(19) United States
(12) Patent Application Publication
(10) Pub. No.: US 2025/0342399 A1
(43) Pub. Date: Nov. 6, 2025

(54) INFORMATION PROCESSING SYSTEM, INFORMATION PROCESSING DEVICE, AND INFORMATION PROCESSING METHOD

(71) Applicants: Preferred Elements, Inc., Tokyo (JP); Preferred Networks, Inc., Tokyo (JP)

(72) Inventors: Kentaro IMAJO, Tokyo (JP); Daiki HIGURASHI, Tokyo (JP); Kosuke NAKAGO, Tokyo (JP); Toshiki KATAOKA, Tokyo (JP); Seiya TOKUI, Tokyo (JP); Gentaro WATANABE, Tokyo (JP)

(21) Appl. No.: 19/191,429

(22) Filed: Apr. 28, 2025

Related U.S. Application Data
(60) Provisional application No. 63/640,981, filed on May 1, 2024.

(30) Foreign Application Priority Data
May 20, 2024 (JP) 2024-082032

(51) Int. Cl. G06N 20/00

(52) U.S. Cl. CPC G06N 20/00

(57) ABSTRACT

An information processing system includes at least one memory, and at least one processor. The at least one processor is configured to obtain information related to an output candidate and a plurality of pieces of target information, calculate first intermediate data by inputting the information related to the output candidate into a machine learning model, and generate output information for each of the plurality of pieces of the target information by executing a single inference process using the machine learning model for each of the plurality of pieces of the target information by using at least a portion of the first intermediate data.

### CROSS-REFERENCE TO RELATED APPLICATIONS

This application is based upon and claims priority to U.S. Provisional Patent Application No. 63/640,981, filed on May 1, 2024, and Japanese Patent Application No. 2024-082032, filed on May 20, 2024, the entire contents of which are incorporated herein by reference.

### BACKGROUND

### 1. Field of the Invention

The present disclosure relates to an information processing system, an information processing device, and an information processing method.

### 2. Description of the Related Art

Machine learning models, such as large language models (LLMs) and the like, are known. Large language models generate output information for each predetermined processed unit, such as a token or the like. Thus, a technique of efficiently handling many inputs and outputs is proposed. For example, there is a technique referred to as a key value cache, which caches data calculated by large language models during decoding. See Omri Mallis, “Techniques for KV Cache Optimization in Large Language Models”, [online], [Retrieved on May 2, 2024], Internet <URL: https://www.omrimallis.com/posts/techniques-for-kv-cache-optimization/>.

### SUMMARY

An information processing system according to an aspect of the present disclosure includes at least one memory, and at least one processor. The at least one processor is configured to: obtain information related to an output candidate and a plurality of pieces of target information; calculate first intermediate data by inputting the information related to the output candidate into a machine learning model; and generate output information for each of the plurality of pieces of the target information by executing a single inference process using the machine learning model for each of the plurality of pieces of the target information by using at least a portion of the first intermediate data.

### BRIEF DESCRIPTION OF THE DRAWINGS

FIG. 1 is a block diagram illustrating an example of an overall configuration of an information processing system according to a first embodiment of the present disclosure.

FIG. 2 is a block diagram illustrating an example of a functional configuration of an inference device according to the first embodiment.

FIG. 3 is a diagram illustrating an example of an inference request according to the first embodiment.

FIG. 4 is a diagram describing an example of an inference process of a Comparative Example.

FIG. 5 is a diagram describing an example of an inference process according to the first embodiment.

FIG. 6 is a diagram illustrating an example of an input screen according to the first embodiment.

FIGS. 7A to 7D are diagrams illustrating examples of an output screen according to the first embodiment.

FIG. 8 is a flowchart illustrating an example of the inference process according to the first embodiment.

FIG. 9 is a diagram illustrating a first example of a prompt according to a second embodiment of the present disclosure.

FIG. 10 is a diagram illustrating a second example of the prompt according to the second embodiment.

FIG. 11 is a block diagram illustrating an example of an overall configuration of an information processing system according to a third embodiment of the present disclosure.

FIG. 12 is a block diagram illustrating an example of a functional configuration of a generation device according to the third embodiment.

FIG. 13 is a diagram illustrating a first example of a prompt according to the third embodiment.

FIG. 14 is a diagram illustrating a second example of the prompt according to the third embodiment.

FIG. 15 is a flowchart illustrating an example of a generation process according to the third embodiment.

FIG. 16 is a diagram describing an example of an attention mask.

FIG. 17 is a diagram illustrating an example of an input screen according to a fourth embodiment of the present disclosure.

FIG. 18 is a block diagram illustrating an example of a hardware configuration of a computer.

### DETAILED DESCRIPTION

The present disclosure provides a technique of generating output information for each of a plurality of pieces of information with a small amount of calculation resources.

Hereinafter, embodiments of the present disclosure will be described with reference to the drawings. In the present specification and drawings, components having substantially the same functional configurations are denoted by the same symbols, and description thereof will be omitted.

### First Embodiment

A first embodiment of the present disclosure is an information processing system configured to execute a predetermined task based on a machine learning model. The machine learning model according to the present embodiment may be an autoregressive model. The autoregressive model may be, as an example, a decoder-only large language model (LLM). The machine learning model may be, for example, a generative model, a foundation model, or a neural network, which is configured to generate various data, such as a voice, an image, a video, and the like. The machine learning model may be a multimodal machine learning model.

The information processing system according to the present embodiment executes a generation task to generate output information for information serving as a target for processing (hereinafter also referred to as “target information”). The generation task may be, as an example, a classification task to classify a plurality of pieces of the target information into predetermined options.

The predetermined option may be represented by a data length that can be generated through a single inference process. The data length that can be generated through the single inference process may be the maximum data length that can be generated through a single inference process executed by a neural network included in a machine learning model. As an example, when the machine learning model is a large language model, the predetermined option may be represented by one token. A token is a processed unit when a machine learning model processes electronic data, and the quantity of data of one token may vary with a design of the machine learning model. The token may be, as an example, one Japanese character or one English word. However, depending on the frequency of occurrence, one character may be represented by two tokens, or two or more characters may be represented by one token.

The generation task according to the present embodiment may be, as an example, a task to assign applicable probabilities of a plurality of options to a plurality of passages, which are examples of the target information. The passage may include one or more sentences. The passage may be, as an example, a message posted on the social networking service. The option may be, as an example, a classification related to an impression given by the passage. The option may include, as an example, “Good impression”, “Bad impression”, or “Neither”. The applicable probability may be, as an example, a probability at which the target information is applicable to each of the options. In other words, the generation task may be a task to determine how good or bad an impression on a message posted on the social networking service is. Specifically, the generation task may be a task to generate output information, e.g., a probability of a good impression on a post is 0.7 and a probability of a bad impression on the post is 0.3. The generation task is not limited to the above example, but may be any task to generate output information of a predetermined length or less for each of a plurality of pieces of the target information.

Conventionally, in the task to classify a plurality of pieces of the target information into predetermined options, it was necessary to re-train a machine learning model for each classification task. The large language model is trained based on a large-scale dataset to execute various tasks, and thus can execute any classification task without being re-trained. However, when a classification task is executed on a plurality of pieces of the target information, it is necessary to execute an inference process using a prompt in which options are assigned to each piece of the target information. Therefore, as the number of pieces of the target information increases, necessary calculation resources increase in total.

The present embodiment provides a technique of generating output information for each of a plurality of pieces of information with a small amount of calculation resources. In the present embodiment, intermediate data of a machine learning model is calculated by inputting information related to an output candidate into the machine learning model, and output information for each of a plurality of pieces of the target information is generated by executing a single inference process using the machine learning model for each of the plurality of pieces of the target information by using the calculated intermediate data. In one aspect, according to the present embodiment, output information is generated while caching and sharing the intermediate data calculated using the information related to the output candidate, and thus output information for each of the plurality of pieces of the target information can be generated with a small amount of calculation. In another aspect, according to the present embodiment, it is not necessary to cache the calculated intermediate data when generating the output information for each of the plurality of pieces of the target information, and thus output information for each of the plurality of pieces of the target information can be generated with a small amount of memory usage.

### <Overall Configuration of Information Processing System>

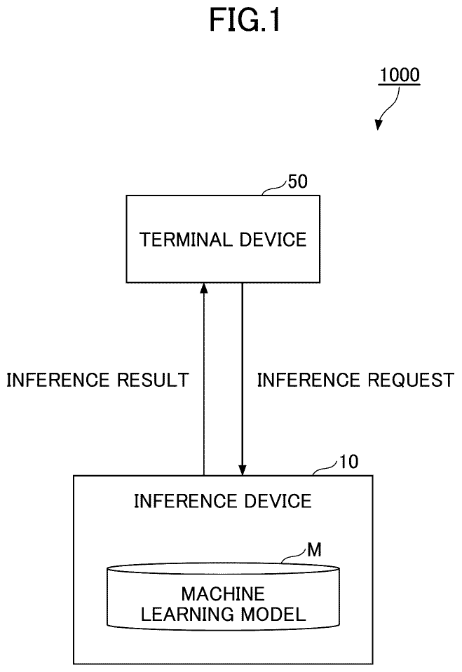

An overall configuration of the information processing system in the present embodiment will be described with reference to FIG. 1. FIG. 1 is a block diagram illustrating an example of the overall configuration of the information processing system according to the first embodiment.

As illustrated in FIG. 1, an information processing system 1000 includes an inference device 10 and a terminal device 50. The inference device 10 and the terminal device 50 may be connected to each other through a communication network, such as a local area network (LAN), the Internet, or the like, so as to enable data communication.

The inference device 10 is an example of an information processing device, such as a personal computer, a work station, a server, or the like, that is configured to execute a predetermined task in response to an inference request from the terminal device 50. The inference device 10 may receive an inference request from the terminal device 50. The inference device 10 may transmit an inference result for the inference request to the terminal device 50.

The inference request is information or a signal requesting execution of a predetermined task. In the present embodiment, the predetermined task may be a task to generate a classification result in which each of the plurality of pieces of the target information is classified into a predetermined option.

The inference device 10 includes a machine learning model M. The machine learning model M is a machine learning model used to execute the predetermined task. The machine learning model M may be an autoregressive model, a generative model, a foundation model, or a neural network. The machine learning model M may be, as an example, a decoder-only large language model.

The machine learning model M may be realized by a single machine learning model. The machine learning model M may be realized by cooperation of a plurality of machine learning models. The machine learning model M may be configured by a plurality of machine learning models corresponding to tasks to be executed. The machine learning model M may be included in information processing devices other than the inference device 10 (e.g., the terminal device 50, other information processing devices, and the like). The machine learning model M may be separately included in an external information processing system including a plurality of information processing devices.

The inference device 10 may be realized by a plurality of information processing devices or information processing systems including different machine learning models M. The inference device 10 may be realized by a single information processing device or information processing system including a plurality of machine learning models M. The inference device 10 may execute a predetermined task using an external machine learning model M. Here, the “external” means that what is modified by “external” is not included in the information processing system 1000.

The terminal device 50 is an example of an information processing device, such as a personal computer, a smartphone, a tablet terminal, or the like, that is operated by a user of the information processing system 1000. The terminal device 50 may transmit an inference request to the inference device 10. The terminal device 50 may receive an inference result from the inference device 10, and present the inference result to a user.

The terminal device 50 may display, as an example, the inference result on a display device of the terminal device 50. The terminal device 50 may output, as an example, a voice obtained by synthesizing the inference result from a speaker of the terminal device 50.

Presenting information to the user may include executing at least a portion of a process necessary for a processor to display information on the display device. The display device may be included in the same device in which the processor is included, or may be included in a device different from a device in which the processor is included. The display device may be a plurality of display devices.

The overall configuration of the information processing system 1000 illustrated in FIG. 1 is merely an example, and various system configuration examples may be possible in accordance with applications and purposes. The information processing system 1000 may include one or more information processing devices. The information processing devices included in the information processing system 1000 may be a system including a plurality of devices. The functions included in the information processing system 1000 may be realized by any device that forms the system. The components included in the information processing system 1000 may be included in any device that forms the system.

At least one of the inference device 10 or the terminal device 50 may be included in two or more in the information processing system 1000. The inference device 10 may be realized by a plurality of computers, or may be realized as a cloud computing service. The segmentation of devices illustrated in FIG. 1, like the inference device 10 and the terminal device 50, is merely an example.

As an example, the information processing system 1000 may include one or more server devices and one or more terminal devices 50. The one or more server devices may include one or more of the functions of the inference device 10. The server device may be realized as a system including a plurality of information processing devices. The server device may be realized as a cloud computing service.

As another example, the information processing system 1000 may include a single information processing device. The information processing device may include the functions of the inference device 10 and the terminal device 50.

### <Functional Configuration of Inference Device>

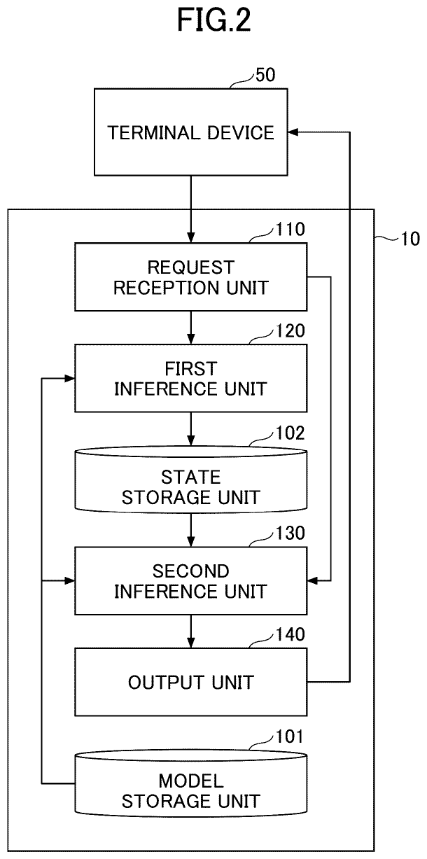

A functional configuration of the inference device 10 will be described with reference to FIG. 2. FIG. 2 is a block diagram illustrating an example of the functional configuration of the inference device according to the first embodiment.

As illustrated in FIG. 2, the inference device 10 includes a model storage unit 101, a state storage unit 102, a request reception unit 110, a first inference unit 120, a second inference unit 130, and an output unit 140. The inference device 10 functions as the model storage unit 101, the state storage unit 102, the request reception unit 110, the first inference unit 120, the second inference unit 130, and the output unit 140 in accordance with a previously installed inference program that is executed by at least one processor.

The machine learning model M is previously stored in the model storage unit 101. The machine learning model M is previously trained based on predetermined training data. As an example, the inference device 10 may learn the machine learning model M, or an external information processing device or information processing system may learn the machine learning model M. A plurality of machine learning models M may be stored in the model storage unit 101.

The state storage unit 102 is configured to store intermediate data of the machine learning model M when information related to the output candidate is input. The intermediate data stored in the state storage unit 102 is generated by the first inference unit 120.

The state storage unit 102 may include a memory of a graphics processing unit (GPU) included in the inference device 10. The state storage unit 102 may include a memory of a central processing unit (CPU) included in the inference device 10. The state storage unit 102 may include an auxiliary storage device, such as a hard disk drive (HDD), a solid state drive (SSD), or the like, included in the inference device 10.

The request reception unit 110 is configured to accept an inference request. The request reception unit 110 may receive an inference request from the terminal device 50. The inference request may be transmitted from the terminal device 50 in response to an operation on a screen displayed on the display device of the terminal device 50. The request reception unit 110 may accept an inference request input to the inference device 10. The inference request may be input to the inference device 10 in response to an operation on the screen displayed on the display device of the inference device 10. At least a portion of the information included in the inference request may be generated by the inference device 10. The request reception unit 110 may obtain an inference request from another information processing device.

In the present embodiment, the inference request is information or a signal requesting generation of output information for the target information. The inference request may include information related to the output candidate and the target information. The information related to the output candidate may include information related to the output candidate generated by an inference process using the machine learning model M. The information related to the output candidate may further include information requesting the inference process using the machine learning model M. The target information may include information related to the target of the inference process using the machine learning model M. The inference request may include a plurality of pieces of the target information. The inference request may include the target information alone, and the information related to the output candidate may be obtained from the inference device 10 or another information processing device. Hereinafter, the information related to the output candidate may be referred to as “candidate information”.

The candidate information may include an option. The option may represent one or more items, elements, contents, and the like included in a plurality of classifications, a plurality of categories, a plurality of classes, a plurality of attributes, a plurality of groups, a plurality of types, a plurality of segments, a plurality of genres, a plurality of kinds, a plurality of sections, a plurality of ranks, a plurality of grades, or the like. The option may include identification information of the option. The identification information of the option may be represented using information that can be generated through a single inference process of the machine learning model M (e.g., one token). The identification information of the option may be, as an example, a number, a symbol, a character, or the like. In the following examples of the candidate information, numbers and alphabetic letters are used as the identification information of the option. For example, the machine learning model M may be configured to represent “1”, “a”, “A”, or the like, which is the identification information of the option, by one token.

### Example 1

```
      “Please select a classification related to the following
passage from the following options.
      Options:
    1: Good impression
    2: Bad impression
    3: Neither”
```

### Example 2

```
      “Please select, from the following options,
as to whether or not the following passage is
appropriate for information related to Company A.
        Options:
      a: Appropriate
      b: Not appropriate
      c: Neither”
```

### Example 3

“Please classify the following news titles into the following categories.
A. Politics
B. Economy
C. Entertainment
D. Sports
E. Science
F. Others”

### Example 4

“Select a season represented by the following passage
from the following options.
Options:
1: Spring
2: Summer
3: Fall
4: Winter”

The candidate information may include an option. Here, the option may be information that can be represented using information that can be generated through a single inference process of the machine learning model M (e.g., one token). Examples of the candidate information include the following. For example, the machine learning model M may be configured to represent each of the options “Spring”, “Summer”, “Fall”, and “Winter” by one token.

### Example 5

“Please select a season represented by the following passage
from the following options.
Options:
Spring
Summer
Fall
Winter”

The candidate information may include information requesting generation of a number. The number may represent a score, a point, a value, or the like. The number may be information that can be represented using information that can be generated through a single inference process of the machine learning model M (e.g., one token). Examples of the candidate information include the following. For example, the machine learning model M may be configured to represent each of the numbers from “0” to “9” by one token.

### Example 6

“Please rate the following passage on a scale of 0 to 9 as to how well it is written in line with business manners.”

### Example 7

“Please rate the following sentence out of 100.”

The candidate information may include information requesting generation of information that can be generated through a single inference process of the machine learning model M (e.g., one token). The information requesting the generation may be a question that can be answered using information that can be generated through a single inference process of the machine learning model M. The information requesting the generation may include information that can specify an option based on common sense or context. Examples of the candidate information include the following. In this example, “Spring”, “Summer”, “Fall”, and “Winter” can be specified as options of an answer, and the machine learning model M may be configured to represent each of “Spring”, “Summer”, “Fall”, and “Winter” by one token.

### Example 8

“Please answer with a season represented by the following passage in English.”

The candidate information may include reference answer information. The reference answer information may include examples of answers, responses, replies, and the like to requests, questions, and the like. The reference answer information may include specific target information and examples of answers, responses, replies, and the like to the specific target information. The reference answer information may include, as the examples of answers, responses, and replies, identification information of the option that can be generated through a single inference process of the machine learning model M, options that can be generated through a single inference process of the machine learning model M, and information specifying a number that can be generated through a single inference process of the machine learning model M. For example, as reference answer information for the above Example 1 of the candidate information, the candidate information may include the following reference answer information.

```
“Passage
      If you have any problems or questions, please feel
      free to contact us.
        Answer
      1”
```

The target information may be a document or a character string. The target information may include text, an image, voice, and a video. The target information may be a combination of two or more of text, an image, voice, and a video. For example, when the candidate information includes an option, the target information may be information to be classified, or may be information that can specify information to be classified.

The first inference unit 120 is configured to calculate intermediate data of the machine learning model M stored in the model storage unit 101, based on the candidate information included in the inference request accepted by the request reception unit 110. The first inference unit 120 may calculate the intermediate data by inputting the candidate information into the machine learning model M. The first inference unit 120 may obtain the intermediate data output by the machine learning model M when the candidate information is input into the machine learning model M.

The input of information into the machine learning model M may include directly or indirectly inputting the information into the machine learning model M. As an example, the input of information into the machine learning model M may include inputting the information as it is into the machine learning model M. The input of information into the machine learning model M may include inputting other information generated based on the information into the machine learning model M.

The intermediate data of the machine learning model M may be at least a portion of the intermediate data calculated by the machine learning model M that executes an inference process on the candidate information. The intermediate data may include, as an example, information related to the state of a hidden layer of a neural network included in the machine learning model M. The intermediate data may include, as an example, information related to the intermediate state of the machine learning model M. The intermediate data may be, as an example, a cache used by the machine learning model M, or information that can be reused to reduce the amount of calculation in the subsequent inference process.

The intermediate data of the machine learning model M may be, as an example, a key value cache. That is, the intermediate data of the machine learning model M may include a key vector and a value vector, among a query vector, a key vector, and a value vector used in an attention mechanism of a transformer. The key value cache may be an array of key vectors and value vectors for each token calculated when candidate information is input into the machine learning model M.

Here, the cache may indicate a process of retaining or storing, in a storage device or the like, data to be used again among data obtained through calculation, or may indicate the retained or stored data. Executing the process of retaining or storing, in a storage device or the like, data to be used again among data obtained through calculation may be referred to as caching. The data to be used again may be retained or stored in a high-speed storage device. The key value cache may include a process of storing key vectors and value vectors, or may include the stored key vectors and value vectors. The cached data may be deleted at a predetermined timing, such as, for example, after the data is used again.

The first inference unit 120 may generate model input information based on candidate information included in the inference request. The first inference unit 120 may input the model input information into the machine learning model M. By inputting the model input information into the machine learning model M, the first inference unit 120 may execute a single inference process using the machine learning model M, and obtain intermediate data calculated through the inference process.

The inference process using the machine learning model M may indicate a process through which obtainment of an inference result (i.e., output information from the machine learning model M) is not a direct object. The inference process executed by the first inference unit 120 is used for calculation of the intermediate data, and thus the inference result obtained through the inference process may be discarded. Also, as long as the inference process executed by the first inference unit 120 includes a process of calculating the intermediate data using the candidate information, the inference process executed by the first inference unit 120 does not necessarily need to include a process after the calculation of the intermediate data. The inference process using the machine learning model M may include, as an example, a forward process using the machine learning model M.

The first inference unit 120 may use the candidate information as the model input information. The first inference unit 120 may generate the model input information by processing the candidate information. The first inference unit 120 may generate the model input information based on a portion of the candidate information. The first inference unit 120 may generate the model input information by extracting a portion of information from the candidate information.

The first inference unit 120 may generate the model input information based on the machine learning model M. The first inference unit 120 may generate the model input information based on another machine learning model (e.g., a generative model, a foundation model, a neural network, or the like). The other machine learning model may be stored in the model storage unit 101. The other machine learning model may be stored in an external information processing device or information processing system.

The first inference unit 120 may generate the model input information by embedding the candidate information in a predetermined template. The template may include one or more placeholders in which the candidate information is embedded. The template may include instruction information for instructing the execution of a task. The template may include constraint information related to the model input information. The instruction information and the constraint information may be predetermined fixed sentences.

The template may be optimized for obtaining good output information by a desired prompt tuning method. The template may be, for example, optimized by searching for an optimal template in accordance with a genetic algorithm or the like based on a benchmark obtained by evaluating a prompt generated using the template.

The model input information may include text data, image data, or acoustic data. The text data may be, as an example, a natural language sentence referred to as a prompt. The image data may be, as an example, a still image or a video. The text data may be text data obtained through voice recognition of voice data recorded in acoustic data or a video. The text data may be text obtained through character recognition of image data. The acoustic data may be voice data.

The first inference unit 120 stores, in the state storage unit 102, the intermediate data of the machine learning model M when the candidate information is input. The first inference unit 120 may store the intermediate data. The first inference unit 120 may store information that can specify the intermediate data. When the first inference unit 120 stores information that can specify the intermediate data, the intermediate data to be used may be specified based on the information that can specify the intermediate data of interest, thereby reading out the specified intermediate data.

The first inference unit 120 may store the intermediate data in a storage device other than the state storage unit 102 or in an information processing device other than the inference device 10. The first inference unit 120 may cause the terminal device 50 to store the intermediate data by transmitting the intermediate data to the terminal device 50. The first inference unit 120 may store the intermediate data in an external storage device or information processing device.

The first inference unit 120 may store, in association, the machine learning model M, the intermediate data, and the candidate information. At least one of the machine learning model M, the intermediate data, or the candidate information may be associated with one another using identification information identifying each of the machine learning model M, the intermediate data, and the candidate information. The first inference unit 120 may associate the machine learning model M, the intermediate data, and the candidate information by any method as long as it is possible to specify different information from predetermined information.

Storing information may include at least one processor executing at least a portion of a process necessary for storing information. Storing information may include caching information.

When the intermediate data corresponding to the same candidate information is already stored in the state storage unit 102, the first inference unit 120 does not necessarily need to calculate the intermediate data corresponding to the candidate information. As an example, when executing a routine task in which the same task is repeatedly executed periodically or irregularly, the intermediate data generated in the past may be used as is. The first inference unit 120 does not need to re-calculate, in the second and subsequent tasks, the intermediate data generated in the first task, thereby reducing calculation resources necessary for executing the task.

The first inference unit 120 may designate whether or not to use the cache when causing the machine learning model M to execute the inference process. Using the cache may include caching the key vectors and the value vectors calculated when the machine learning model M executes a forward process. The first inference unit 120 may designate to perform caching of the key vectors and the value vectors.

The second inference unit 130 is configured to, using the intermediate data calculated by the first inference unit 120, generate output information for each of the plurality of pieces of the target information by executing a single inference process using the machine learning model M stored in the model storage unit 101 for each of the plurality of pieces of the target information included in the inference request accepted by the request reception unit 110. The second inference unit 130 may read out the intermediate data stored (cached) in the state storage unit 102, and generate output information for the target information by inputting one of the plurality of pieces of the target information and the intermediate data into the machine learning model M. The second inference unit 130 may obtain the output information output by the machine learning model M when the target information and the intermediate data are input into the machine learning model M. When executing the inference process using the intermediate data, for calculation in each of the layers included in the machine learning model M, the second inference unit 130 may read out and use the cached intermediate data corresponding to each layer from the state storage unit 102.

The second inference unit 130 may generate pieces of the output information, in parallel, for two or more pieces of the target information among the plurality of pieces of the target information. Hereinafter, parallel processing of two or more pieces of the target information may be referred to as a “batch process”, and the number of pieces of the target information to be processed in parallel may be referred to as a “batch size”. The second inference unit 130 may cause a single GPU included in the inference device 10 to execute the batch process of the target information. The second inference unit 130 may cause a plurality of GPUs included in the inference device 10 to execute the batch process of two or more pieces of the target information. The first inference unit 120 may, as a batch, calculate the intermediate data using the candidate information and store the calculated intermediate data in the state storage unit 102.

When executing the batch process of the plurality of pieces of the target information, the second inference unit 130 may copy the batch size of the intermediate data cached in the state storage unit 102, and cause the GPU to process the batch size of the intermediate data. The second inference unit 130 may copy the intermediate data only when necessary. As an example, in a forward process using the machine learning model M having a plurality of layers, the second inference unit 130 may copy only the information necessary for each layer in the intermediate data.

The second inference unit 130 may generate the model input information based on the target information included in the inference request. The second inference unit 130 may generate a plurality of pieces of model input information based on each of the plurality of pieces of the target information. The second inference unit 130 may separate the target information into a plurality of chunks, and generate model input information for each of the chunks. The second inference unit 130 may input the model input information and the intermediate data into the machine learning model M.

The second inference unit 130 may execute a single inference process using the machine learning model M and obtain the output information generated through the inference process by inputting the model input information and the intermediate data into the machine learning model M. The second inference unit 130 may re-calculate a portion of the intermediate data during the inference process.

The second inference unit 130 does not necessarily need to store the intermediate data of the machine learning model M calculated when the target information is input. The second inference unit 130 does not necessarily need to store the intermediate data calculated in the process of executing a single inference process for the target information, for an inference process after the single inference process using the machine learning model M. The second inference unit 130 may be configured not to store the intermediate data calculated in the process of executing the single inference process for some pieces of the target information among the plurality of pieces of the target information.

Not to store the intermediate data for the inference process after the single inference process using the machine learning model M may include at least one of: not to cache the intermediate data for the subsequent inference process; not to execute a command to cache the intermediate data for the subsequent inference process; to delete the intermediate data before executing the subsequent inference process; or to execute a command to release the intermediate data before executing the subsequent inference process. Not to store the intermediate data for the inference process after the single inference process using the machine learning model M may not be on the basis of the assumption that the subsequent inference process will be executed. That is, the subsequent inference process may be set not to be executed, and the single inference process alone may be executed.

The second inference unit 130 may designate whether or not to use a cache when causing the machine learning model M to execute the inference process. The second inference unit 130 may designate to refer to the key vectors and value vectors cached in the state storage unit 102. The second inference unit 130 may designate not to cache the key vectors and value vectors calculated by executing the inference process for the target information. If the second inference unit 130 does not cache the key vectors and value vectors, a memory size used for the key value cache can be reduced. As a result, the batch size in the batch process can be increased, and thus higher efficiency of the batch process can be realized.

The second inference unit 130 may add a fixed token to the end of the target information. The fixed token may be a token meaning the end of the target information, or may be a token instructing the start of the answer.

In the present embodiment, the second inference unit 130 may obtain, for each piece of the target information, a token (e.g., one token) obtained through the single inference process using the intermediate data cached in the state storage unit 102 and the machine learning model M. The second inference unit 130 may not execute, for each piece of the target information, the second or subsequent inference processes using the machine learning model M.

The output information of the machine learning model M generated by the second inference unit 130 may include probability information. The probability information may be a probability distribution, a logit vector, a probability vector, or one or more probability values. The output information may include probability information of all tokens that can be processed by the machine learning model M. Also, the output information may include probability information of tokens requested to be generated by the candidate information (tokens corresponding to the identification information of options, options, numbers, and the like) and may not include probability information of other tokens. For example, when the candidate information is the above Example 1, the output information may include probability information of three tokens “1”, “2”, and “3” that are identification information of the options, and may not include probability information of other tokens.

Also, the output information may include tokens selected based on the probability information. The selected tokens may be limited in advance to tokens requested to be generated by the candidate information (tokens corresponding to the identification information of options, options, numbers, and the like). For example, among a plurality of tokens corresponding to each of pieces of the identification information of the options, the token in which the machine learning model M shows the highest probability value or the token selected based on the probability distribution may be used as the output information corresponding to the target information. Also, the output information corresponding to the target information may be at least a portion of the information output through the inference process of the machine learning model M, or may be information generated based on the output information.

The output unit 140 is configured to, based on the output information generated by the second inference unit 130, output an inference result for the inference request accepted by the request reception unit 110. The output unit 140 may output the inference result including the output information for each of the plurality of pieces of the target information included in the inference request. The output unit 140 may transmit, to the terminal device 50, the inference result including the plurality of pieces of the output information. The output unit 140 may display the inference result including the plurality of pieces of the output information related to the display device of the inference device 10. The inference result is an example of the fifth information. The inference result may include at least a portion of the output information, or may be information generated based on the output information. The inference result may be information the same as the output information.

The output unit 140 may cause, for each of the plurality of pieces of the target information, the inference result to include a token indicating the highest probability value or a token selected based on the probability distribution. The output unit 140 may determine information to be included in the inference result, based on the probability information included in the output information for each of the plurality of pieces of the target information. The output unit 140 may cause, for each of the plurality of pieces of the target information, the inference result to include tokens requested to be generated by the candidate information (tokens corresponding to the identification information of options, options, numbers, and the like) and the probability values of these tokens. The output unit 140 may include, in the inference result, values calculated based on the probability information included in the output information as the probability values. As an example, the output unit 140 may normalize each of the probability values such that the sum of the probability values of the tokens corresponding to the identification information of the options becomes one. The second inference unit 130 may be configured to generate output information including the normalized probability values.

The output unit 140 may extract the target information to be included in the inference result from the plurality of pieces of the target information included in the inference request. The output unit 140 may extract the target information to be included in the inference result based on the output information for each of the plurality of pieces of the target information. As an example, the output unit 140 may extract the target information to be included in the inference result by comparing a probability value included in the output information for each of the plurality of pieces of the target information with a predetermined threshold. The output unit 140 may transmit, to the terminal device 50, the plurality of pieces of the target information and the probability information, and cause the terminal device 50 to extract the target information.

In order for the output unit 140 to obtain only the probability information of the tokens requested to be generated by the candidate information (tokens corresponding to the identification information of options, options, numbers, and the like), the machine learning model M may be configured to calculate only the probability information of the tokens requested to be generated by the candidate information in the final layer. As an example, the final layer of the machine learning model M according to the present embodiment may be a matrix of the number of tokens corresponding to the identification information of options×the number of channels.

The final layer of conventional large language models is a matrix of the total number of tokens×the total number of channels. As an example, conventional large language models output about 50,000 tokens, and thus the amount of calculation required for calculating the output information and the amount of data of the output information become enormous. According to the present embodiment, the number of tokens to be output by the machine learning model M can be limited based on the candidate information, and thus the amount of calculation of the machine learning model M and the amount of transfer of the output information can be reduced. Also, according to the present embodiment, probability information of all tokens is not output, and thus, distillation of the machine learning model M does not readily occur and the machine learning model M can be protected. Further, according to the present embodiment, it is possible to determine options and the like using only the probability information of the tokens requested to be generated by the candidate information (tokens corresponding to the identification information of options, options, numbers, and the like), and thus, accuracy of classification can be increased.

### <Prompt>

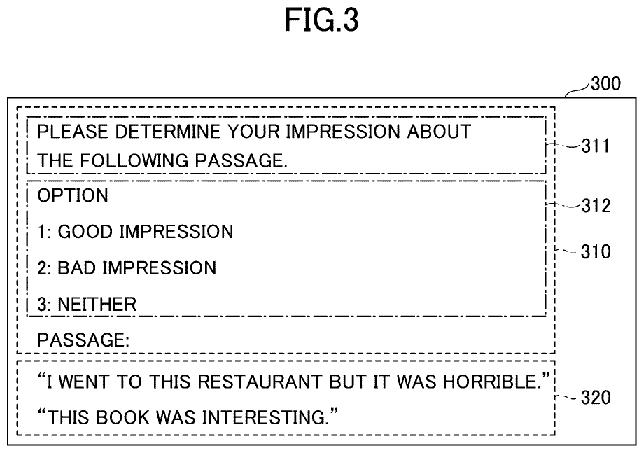

A prompt, which is an example of the model input information, will be described with reference to FIG. 3. FIG. 3 is a diagram illustrating an example of an inference request according to the first embodiment.

As illustrated in FIG. 3, an inference request 300 may include candidate information 310 and target information 320. The candidate information 310 may include question information 311 and option information 312. The question information 311 may include information indicating the content of the question (“Please determine your impression about the following passage.”). The option information 312 may include identification information (1, 2, 3) of an option and the content of the option (Good impression, Bad impression, or Neither).

The target information 320 may include a plurality of pieces of target information (“I went to this restaurant but it was horrible” and “This book was interesting”). The target information 320 illustrated in FIG. 3 indicates the boundary between the pieces of the target information by a newline symbol or a quotation mark, but as an example, the boundary between the pieces of the target information may be indicated by any symbol, such as a comma, a colon, a semicolon, or the like. The quotation mark may not be included in the target information.

The first inference unit 120 may obtain the candidate information 310 in the inference request 300, and generate a prompt to be input into the machine learning model M. The second inference unit 130 may obtain any one of the pieces of the target information 320 in the inference request 300, and generate a prompt to be input into the machine learning model M.

### <Inference Process>

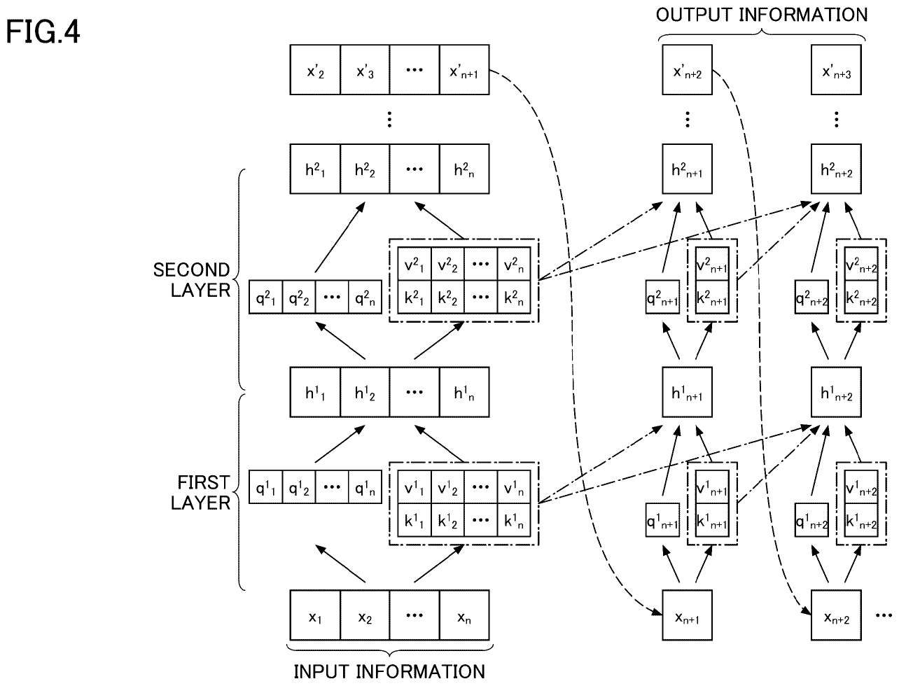

Differences between an inference process according to a Comparative Example and the inference process according to the present embodiment will be described with reference to FIGS. 4 and 5. FIG. 4 is a diagram describing an example of the inference process of the Comparative Example. FIG. 5 is a diagram describing an example of the inference process according to the first embodiment.

FIGS. 4 and 5 schematically illustrate forward processes executed by a transformer included in the machine learning model M. FIGS. 4 and 5 partially illustrate the layers, processes, data, and the like of the transformer included in the machine learning model M. The machine learning model M may include structures not illustrated in FIGS. 4 and 5, such as layers, processes, data, and the like.

As illustrated in FIG. 4, in the inference process of the Comparative Example, in response to an input of input information including a plurality of tokens x₁, . . . , xₙ, a forward process using the input information x₁, . . . , xₙ is executed. The first layer calculates query vectors q¹₁, . . . , q¹ₙ, key vectors k¹₁, . . . , k¹ₙ, and value vectors v¹₁, . . . , v¹ₙ corresponding to the tokens x₁, . . . , xₙ, and outputs hidden vectors h¹₁, . . . , h¹ₙ using these vectors. The hidden vectors h¹₁, . . . , h¹ₙ output from the first layer are input to the second layer. The second layer calculates query vectors q²₁, . . . , q²ₙ, key vectors k²₁, . . . , k²ₙ, and value vectors v²₁, . . . , v₂ⁿ, corresponding to the hidden vectors h¹₁, . . . , h¹ₙ, and outputs hidden vectors h²₁, . . . , h²ₙ using these vectors. The transformer repeatedly executes the same process in each layer, and outputs the next tokens x′₂, . . . , x′ₙ₊₁ for the tokens x₁, . . . , xₙ. At this time, the transformer caches the key vectors k¹₁, . . . , k²₁, . . . and the value vectors v¹₁, . . . , v²₁, . . . calculated in each layer (enclosed by dashed lines).

After completion of the inference process using the input information x₁, . . . , xₙ, an inference process using the next token x_{n +1} is executed. The first layer calculates a query vector q¹ₙ₊₁, a key vector k¹ₙ₊₁, and a value vector v¹ₙ₊₁ corresponding to the token xₙ₊₁, and outputs a hidden vector h¹ₙ₊₁ using the query vector q¹ₙ₊₁, the key vectors k¹₁, . . . , k¹ₙ₊₁, and the value vectors v¹₁, . . . , v¹ₙ₊₁. The hidden vector h¹ₙ₊₁ output from the first layer is input to the second layer. The second layer calculates a query vector q²ₙ₊₁, a key vector k²ₙ₊₁, and a value vector v²ₙ₊₁ corresponding to the hidden vector h¹ₙ₊₁, and outputs a hidden vector h²ₙ₊₁ using the query vector q²ₙ₊₁, the key vectors k²₁, . . . , k²ₙ₊₁, and the value vectors v²₁, . . . , v²ₙ₊₁. The transformer repeatedly executes the same process in each layer, and outputs the next token x′ₙ₊₂ for the token xₙ₊₁. At this time, the transformer caches the key vectors k¹ₙ₊₁, k²ₙ₊₁, . . . and the value vectors v¹ₙ₊₁, v²ₙ₊₁, . . . calculated in each layer (enclosed by dashed lines).

In this manner, the inference process of the Comparative Example infers the next token for the input token by using, in each layer of the transformer, the query vectors, the key vectors, and the value vectors corresponding to the most-recent token, and the key vectors and the value vectors corresponding to all the tokens cached in the past. Therefore, the key vectors and the value vectors calculated in each layer are cached for use in the subsequent forward process. The key value cache enables the machine learning model M to reuse the key vectors and the value vectors calculated in the past, and execute the inference process at high speed.

As illustrated in FIG. 5, in the inference process according to the present embodiment, in response to an input of candidate information including a plurality of tokens x₁, . . . , xₙ, a forward process using candidate information x₁, . . . , xₙ is executed. The first layer calculates query vectors q¹ₓ₁, . . . , q¹ₓₙ, key vectors k¹ₓ₁, . . . , k¹ₓₙ, and value vectors v¹ₓ₁, . . . , v¹ₓₙ corresponding to the tokens x₁, . . . , xₙ, and outputs hidden vectors h¹ₓ₁, . . . , h¹ₓₙ using these vectors. The hidden vectors h¹ₓ₁, . . . , h¹ₓₙ output from the first layer are input to the second layer. The second layer calculates query vectors q²ₓ₁, . . . , q²ₓₙ, key vectors k²ₓ₁, . . . , k²ₓₙ, and value vectors v²ₓ₁, . . . , v²ₓₙ corresponding to the hidden vectors h¹ₓ₁, . . . , h¹ₓₙ, and outputs hidden vectors h²ₓ₁, . . . , h²ₓₙ using these vectors. The transformer repeatedly executes the same process in each layer, and outputs the next tokens x′₂, x′₃, . . . , x′ₙ₊₁ for the tokens x₁, . . . , xₙ. At this time, the transformer caches the key vectors k¹ₓ₁, . . . , k²ₓ₁, . . . and the value vectors v¹ₓ₁, . . . , v²ₓ₁, . . . calculated in each layer (enclosed by dashed lines).

After completion of the inference process using the candidate information x₁, . . . , xₙ, a batch process is executed for target information 1 including a plurality of tokens y₁, . . . , yₘ and target information 2 including a plurality of tokens z₁, . . . , zₖ. Here, the inference process according to the present embodiment is executed for the target information 1 and the target information 2 by using the key vectors k¹ₓ₁, . . . , k²ₓ₁, . . . and the value vectors v¹ₓ₁, . . . , v²ₓ₁, . . . of each layer calculated through the inference process or the candidate information and cached in the state storage unit 102. In the inference process using the target information 1, the first layer calculates query vectors q′_{y1}, . . . , q′_{ym}, key vectors k¹_{y1}, . . . , k¹_{ym}, and value vectors v¹_{y1}, . . . , v¹_{ym} corresponding to the tokens y₁, . . . , yₘ, and outputs hidden vectors h¹_{y1}, . . . , h¹_{ym} using the query vectors q¹_{y1}, . . . , q¹_{ym}, the key vectors k¹ₓ₁, . . . , k¹ₓₙ, k¹_{y1}, . . . , k¹_{ym}, and the value vectors v¹ₓ₁, . . . , v¹ₓₙ, v¹_{y1}, . . . , v¹_{ym}. The hidden vectors h¹_{y1}, . . . , h¹_{ym} output from the first layer are input to the second layer. The second layer calculates query vectors q²_{y1}, . . . , q₂^{ym}, key vectors k²_{y1}, . . . , k²_{ym}, and value vectors v²_{y1}, . . . , v²_{ym} corresponding to the hidden vectors h¹_{y1}, . . . , h¹_{ym}, and outputs hidden vectors h²_{y1}, . . . , h²_{ym} using the query vectors q²_{y1}, . . . , q²_{ym}, the key vectors k²ₓ₁, . . . , k²ₓₙ, k²_{y1}, . . . , k²_{ym}, and the value vectors v²ₓ₁, . . . , v²ₓₙ, v²_{y1}, . . . , v²_{ym}. The transformer repeatedly executes the same process in each layer, and outputs output information y′ₘ₊₁ for the target information y₁, . . . , yₘ.

At this time, the transformer may not cache the key vectors k¹_{y1}, . . . , k¹_{ym}, k²_{y1}, . . . , k²_{ym}, and the value vectors v¹_{y1}, . . . , v¹_{ym}, v²_{y1}, . . . , v²_{ym} calculated in each layer. After completion of the inference process using the target information y₁, . . . , yₘ, the transformer may delete the key vectors k¹_{y1}, . . . , k¹_{ym}, k²_{y1}, . . . , k²_{ym}, and the value vectors v¹_{y1}, . . . , v¹_{ym}, v²_{y1}, . . . , v²_{ym} from the memory. The transformer may not execute a command to cache the key vectors k¹_{y1}, . . . , k¹_{ym}, k²_{y1}, . . . , k²_{ym}, and the value vectors v¹_{y1}, . . . , v¹_{ym}, v²_{y1}, . . . , v²_{ym} or the subsequent inference process. The transformer may execute a command not to cache the key vectors k¹_{y1}, . . . , k¹_{ym}, k²_{y1}, . . . , k²_{ym}, and the value vectors v¹_{y1}, . . . , v¹_{ym}, v²_{y1}, . . . , v²_{ym} for the subsequent inference process. After calculation of the hidden vectors h¹_{y1}, . . . , h¹_{ym} yet before output of the output information y′ₘ₊₁, the query vectors q′_{y1}, . . . , q¹_{ym}, the key vectors k¹_{y1}, . . . , k¹_{ym}, and the value vectors v¹_{y1}, . . . , v¹_{ym} may be deleted from the memory. Similarly, after calculation of the hidden vectors h²_{y1}, . . . , h²_{ym} yet before output of the output information y′ₘ₊₁, the query vectors q²_{y1}, . . . , q²_{ym}, the key vectors k²_{y1}, . . . , k²_{ym}, and the value vectors v²_{y1}, . . . , v²_{ym} may be deleted from the memory.

An inference process using the target information 2 is executed in the same manner as in the inference process using the target information 1. That is, the first layer calculates query vectors q¹_{z1}, . . . , q¹_{zk}, key vectors k¹_{z1}, . . . , k¹_{zk}, and value vectors v¹_{z1}, . . . , v¹_{zk} corresponding to the tokens z₁, . . . , zₖ, and outputs hidden vectors h¹_{z1}, . . . , h¹_{zk} using the query vectors q¹_{z1}, . . . , q¹_{zk}, the key vectors k¹ₓ₁, . . . , k¹ₓₙ, k¹_{z1}, . . . , k¹_{zk}, and the value vectors v¹ₓ₁, . . . , v¹ₓₙ, v¹_{z1}, . . . , v¹_{zk}. The hidden vectors h¹_{z1}, . . . , h¹_{zk} output from the first layer are input to the second layer. The second layer calculates query vectors q²_{z1}, . . . , q²_{zk}, key vectors k²_{z1}, . . . , k²_{zk}, and value vectors v²_{z1}, . . . , v²_{zk} corresponding to the hidden vectors h¹_{z1}, . . . , h¹_{zk}, and outputs hidden vectors h²_{z1}, . . . , h²_{zk} using the query vectors q²_{z1}, . . . , q²_{zk}, the key vectors k²ₓ₁, . . . , k²ₓₖ, k²_{z1}, . . . , k²_{zk}, and the value vectors v²ₓ₁, . . . , v²ₓₖ, v²_{z1}, . . . , v²_{zk}. The transformer repeatedly executes the same process in each layer, and outputs output information z′ₖ₊₁ for the target information z₁, . . . , zₖ. At this time, the transformer may not cache the key vectors k¹_{z1}, . . . , k¹_{zk}, k²_{z1}, . . . , k²_{zk} and the value vectors v¹_{z1}, . . . , v¹_{zk}, v²_{z1}, . . . , v²_{zk} calculated in each layer. After calculation of the hidden vectors h¹_{z1}, . . . , h¹_{zk} yet before output of the output information z′ₖ₊₁, the query vectors q¹_{z1}, . . . , q¹_{zk}, the key vectors k¹_{z1}, . . . , k¹_{zm}, and the value vectors v¹_{z1}, . . . , v¹_{zm} may be deleted from the memory. Similarly, after calculation of the hidden vectors h²_{z1}, . . . , h²_{zk} yet before output of the output information z′ₖ₊₁, the query vectors q²_{z1}, . . . , q²_{zk}, the key vectors k²_{z1}, . . . k²_{zk}, and the value vectors v²_{z1}, . . . , v²_{zk} may be deleted from the memory.

In the present embodiment, the key vectors and the value vectors corresponding to the candidate information are cached and shared in the inference process for each piece of the target information. Thus, the calculation of the key vectors and the value vectors corresponding to the candidate information can be omitted in the inference process for the target information. Also, in the inference process for the target information, the query vectors, the key vectors, and the value vectors corresponding to each piece of the target information do not need to be cached for the subsequent inference process. Thus, the memory usage necessary for the inference process for the target information can be reduced. Also, when the memory usage is reduced, the required memory bandwidth can be reduced, and thus even existing GPUs and the like can be readily optimized.

### <User Interface>

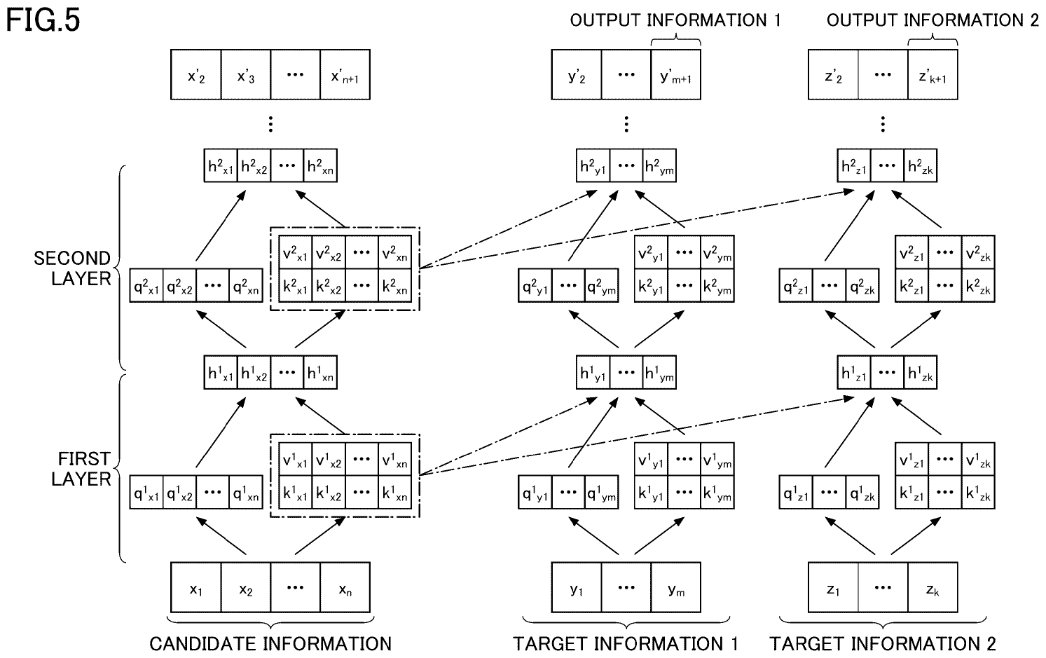

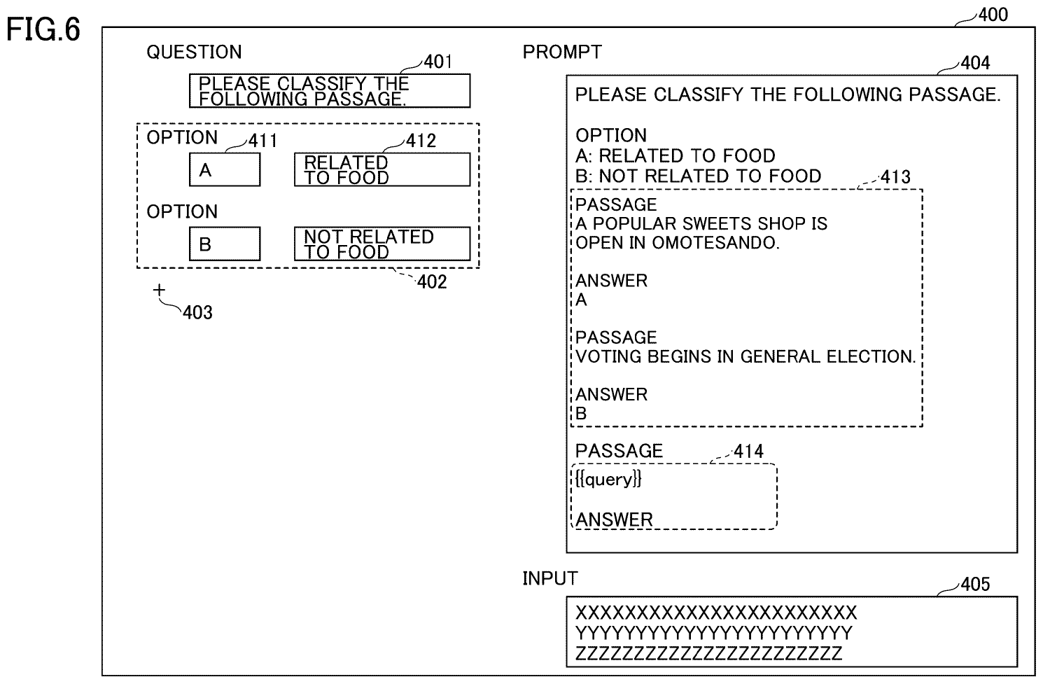

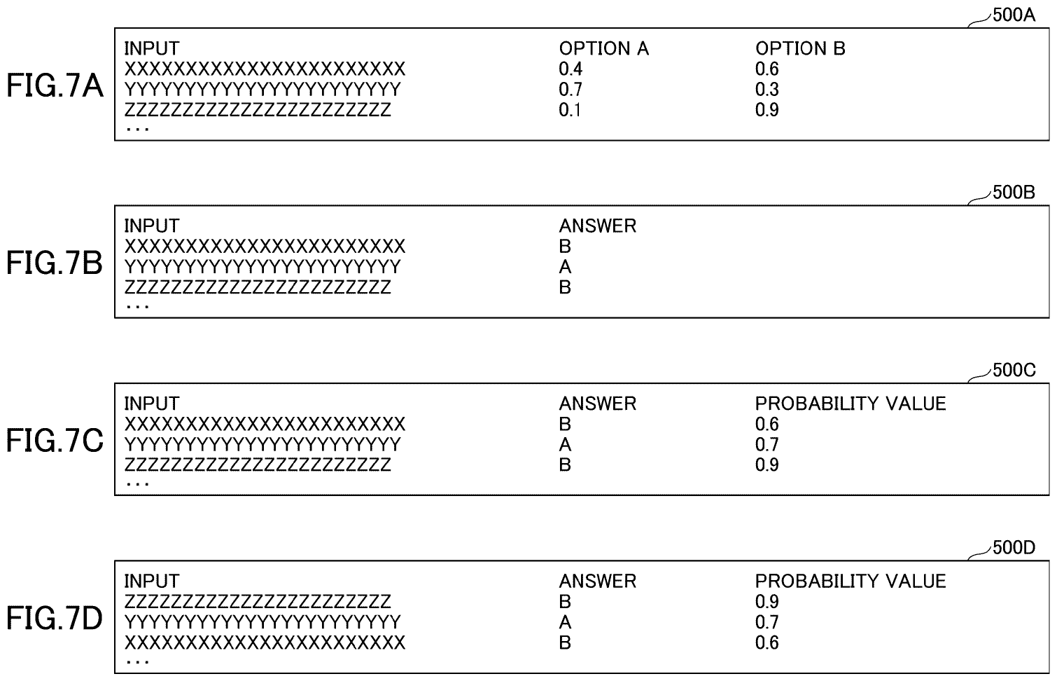

A user interface provided by the inference device 10 will be described with reference to FIGS. 6 and 7. The user interface of the inference device 10 is, as an example, displayed on the display device of the inference device 10 or the terminal device 50. In the present embodiment, an example in which a screen is displayed on the display device of the terminal device 50 will be described.

The user interface of the inference device 10 may include, as an example, an input screen and an output screen. The input screen is a screen configured to receive an input of candidate information and target information. The output screen is a screen configured to display an inference result for the target information.

### <<Input Screen>>

FIG. 6 is a diagram illustrating an example of an input screen according to the first embodiment. As illustrated in FIG. 6, an input screen 400 may include a question input field 401, an option input field 402, an option addition button 403, an input information display field 404, and a target information input field 405.

The question input field 401 is configured to accept an input of a question to be included in the candidate information. The question input field 401 may automatically receive the input of the question by the information processing system 1000. Alternatively, a user of the information processing system 1000 may input or edit the question.

The option input field 402 accepts an input of an option to be included in the candidate information. The option input field 402 may include an identification information input field 411 and an explanation input field 412. The identification information input field 411 is configured to accept an input of identification information of an option. The identification information input field 411 may accept selection of identification information from a list of pieces of predetermined identification information.

The option input field 402 illustrates an example of information for obtaining the candidate information. The information for obtaining the candidate information may include information for directly obtaining the candidate information, or may include information for obtaining information necessary for obtaining the candidate information.

The explanation input field 412 is configured to accept an input of an explanation of an option (including content of the option). The option input field 402 may automatically receive the input of the explanation by the information processing system 1000. Alternatively, a user of the information processing system 1000 may input or edit the explanation. As an example, when a user inputs an explanation to the explanation input field 412, identification information may be automatically input to the identification information input field 411. When identification information of an option is automatically assigned by the information processing system 1000, the identification information of the option may not be displayed on the input screen 400. The first inference unit 120 may use the identification information assigned to the option, and generate candidate information including the assigned identification information.

The identification information input field 411 may be configured to receive an input of numbers (e.g., 1 to 10, and the like), characters (e.g., A to Z, a to z, and the like), symbols, and the like. When such an input is automatically performed, the identification information input field 411 may select the identification information from information that can be represented using information that can be generated through a single inference process using the machine learning model M (e.g., one token). When a user inputs the identification information, the identification information input field 411 may determine whether or not the input identification information is a token that can be generated through a single inference process. As an example, the identification information input field 411 may use a desired tokenizer to determine whether or not the identification information input by the user can be generated through a single inference process.

The identification information input field 411 may determine whether or not the identification information can be generated through a single inference process, and notify a user of the determination result. As an example, when the identification information cannot be represented by a token that can be generated through a single inference process (e.g., one token), the input screen 400 may notify that the identification information cannot be set. As an example, the notification that the identification information cannot be set may include displaying a pop-up of an error message or outputting a beep sound.

The option input field 402 may receive, from a user, an option that can be represented by information that can be generated through a single inference process using the machine learning model M (e.g., one token). In this case, the option input field 402 may not obtain identification information via the identification information input field 411. Also, when the accepted option cannot be represented by information that can be generated through a single inference process, a user may be notified of this.

The option addition button 403 is a button configured to add a new option to the option input field 402. When a user presses the option addition button 403, the identification information input field 411 and the explanation input field 412 are added to the option input field 402. The added identification information input field 411 may automatically receive an input of identification information that is different from the identification information in the existing identification information input field 411. The input screen 400 may include a delete button configured to delete the option included in the option input field 402.

The input screen 400 includes the question input field 401, the option input field 402, and the option addition button 403, and thus questions and options can be changed on demand. Therefore, a user can utilize a desired task in a timely manner via the input screen 400.

The option input field 402 illustrated in FIG. 6 includes two options, but may include three or more options. Also, although the option input field 402 presents options having opposing contents (Related to food, or Not related to food), the contents of the options may not be opposing.

The input information display field 404 is configured to display the model input information. The input information display field 404 may automatically generate the model input information based on information input to the question input field 401 and the option input field 402. The input screen 400 may include a button configured to generate the model input information to be displayed on the input information display field 404. The input information display field 404 may display the model input information in a manner that can be edited by a user with a text editor or the like.

The input information display field 404 may include reference answer information 413. The reference answer information 413 may include a combination of target information and examples of an answer. The reference answer information 413 may include a plurality of sets of pieces of target information and examples of an answer. The reference answer information 413 may be generated based on information from a user, or may be generated based on information input to the question input field 401 and the option input field 402. The reference answer information 413 may be generated based on the machine learning model M or another machine learning model.

The input information display field 404 may include a placeholder 414. The placeholder 414 may include a placeholder ({{query}}) for embedment of target information. The placeholder 414 may include information instructing the start of answering (e.g. “Answer” or the like). The information instructing the start of answering may be a predetermined fixed sentence. The information instructing the start of answering may be omitted. As an example, the placeholder 414 illustrated in FIG. 6 may be the placeholder ({{query}}) alone.

The target information input field 405 is configured to accept an input of the target information. The target information input field 405 may accept an input of a plurality of pieces of the target information. A user may input or edit the target information of the target information input field 405. Although the target information masked with X, Y, and Z is illustrated in the target information input field 405 of FIG. 6, text described in a natural language sentence or the like may be input.

The target information input field 405 may accept an input of an electronic file in which the target information is described. As an example, the target information input field 405 may receive an input of the target information by operations, such as, for example, a user's operation to drag and drop an electronic file.

The electronic file may be recorded in a predetermined file format. The predetermined file format may include, as an example, a text file, an image file, a video file, an audio file, a spreadsheet file, a presentation file, a PDF (Portable Document Format) file, and the like.

The electronic file may include the target information described in a predetermined format. The predetermined format may include, as an example, a CSV (Comma Separated Value) format, a markdown notation, an HTML (Hyper Text Markup Language) format, an XML (Extensible Markup Language) format, a JSON (JavaScript Object Notation) format, a JSONL (JSON Lines) format, and the like. When the target information is described in a CSV format, the column name (e.g., “Passage” or the like) may be described at the first line of an electronic file, and the target information may be described at the second and subsequent lines. When the target information is described in a JSON format or JSONL format, the target information may be described as a sequence.

The electronic file may include a plurality of columns. As an example, when performing a task to evaluate translation results, the electronic file may include a column indicating a passage described in a first language and a column indicating a passage described in a second language. The target information of the task to evaluate the translation results may be described as follows. In the following example, {en} is a placeholder in which a passage described in English is to be embedded, and {ja} is a placeholder in which a passage described in Japanese is to be embedded.

### Example 1

“English: {en}
Japanese: {ja}
Grade:”

The target information input field 405 may receive an input of information retrieved from an external data source. The external data source may include, as an example, a social networking service, a search engine, a database, a website, and the like. The external data source may include a plurality of data sources.

The target information input field 405 illustrates an example of information for obtaining the target information. The information for obtaining the target information may include information for directly obtaining the target information, or may include information for obtaining information necessary for obtaining the target information.

When the target information is input to the target information input field 405 while the model input information is displayed on the input information display field 404, the input screen 400 may generate the model input information by embedding the target information, input to the target information input field 405, in the placeholder 414, and transmit the generated model input information to the inference device 10 as an inference request. The input screen 400 may include a button configured to transmit an inference request.

In FIG. 6, a portion of the input information display field 404 excluding the placeholder 414 corresponds to the candidate information included in the inference request. Therefore, the first inference unit 120 of the inference device 10 may calculate intermediate data (key value cache) by inputting, into the machine learning model M, the portion of the input information display field 404 excluding the placeholder 414. Also, the second inference unit 130 of the inference device 10 may generate output information for each of the plurality of pieces of the target information by executing a batch process of a plurality of pieces of the target information input to the target information input field 405. At this time, the second inference unit 130 may input the key value cache, generated by the first inference unit 120, into the machine learning model M.

### <<Output Screen>>

FIGS. 7A to 7D are diagrams illustrating examples of the output screen. FIG. 7A illustrates an output screen 500A that displays probability values of the respective pieces of the target information for each of the options. FIG. 7B illustrates an output screen 500B that displays the option having the highest probability value for each piece of the target information. FIG. 7C illustrates an output screen 500C that displays the option having the highest probability value and the probability value of the option for each piece of the target information. FIG. 7D illustrates an output screen 500D that displays the option having the highest probability value and the probability value of the option for each piece of the target information, in a descending order of probability value.

The probability value displayed on the output screen 500 may be only the probability value of the token corresponding to the option. In this case, the probability value of the token other than the option may be discarded. In FIGS. 7A to 7D, the probability value is displayed as a numerical value of 0 or more and 1 or less, but as another example, the probability value may be displayed as a percentage, or may be displayed in another form that enables understanding of which option has a high or low probability value. In FIGS. 7A to 7D, the inference result is displayed for all pieces of the target information, but only the inference results for some pieces of the target information may be displayed. As an example, only a predetermined number of pieces of the target information having high probability values may be displayed.

In FIG. 7A, the probability values for each option are normalized such that the sum of the probability values becomes 1, but normalization of the probability values may be performed such that the sum of the probability values becomes a different value, or normalization of the probability values may not be performed. In FIG. 7A, the probability values for all the options are displayed, but only the probability values for some options may be displayed. The options to be displayed may be selected based on the probability values. In FIG. 7D, the probability values are arranged in a descending order of probability value, but the probability values may be arranged in an ascending order of probability value.

In FIG. 7A, the probability values are displayed for all the options, but the probability values may be displayed only for some options. For example, in FIG. 7A, only the probability values for Option A may be displayed. In this case, pieces of the target information may be arranged in a descending or ascending order based on the probability values for Option A. Alternatively, only pieces of the target information having probability values for Option A that are equal to or more than a predetermined threshold may be displayed. In this case, the pieces of the target information having probability values for Option A that are equal to or more than the predetermined threshold may be arranged in a descending or ascending order based on the probability values for Option A. Also, information based on the option that is selected based on the probability information may be displayed on the output screen 500 as the inference result. For example, a predetermined symbol or the like corresponding to the selected option may be displayed on the output screen 500 as the inference result. Also, when output information related to a plurality of classifications is generated for a single piece of the target information, the inference results for each of the plurality of classifications may be simultaneously displayed on the output screen 500.

The output screen 500 may store the inference result in a predetermined file format. The predetermined file format may be the same as the format of an electronic file used for inputting the target information to the input screen 400.

### <<Other Screens>

The user interface of the inference device 10 may include a screen configured to select, from a plurality of machine learning models, a machine learning model that is caused to execute a predetermined task. The user interface of the inference device 10 may include a screen configured to receive an input of setting information related to a selectable machine learning model.

### <Flow of Inference Process>

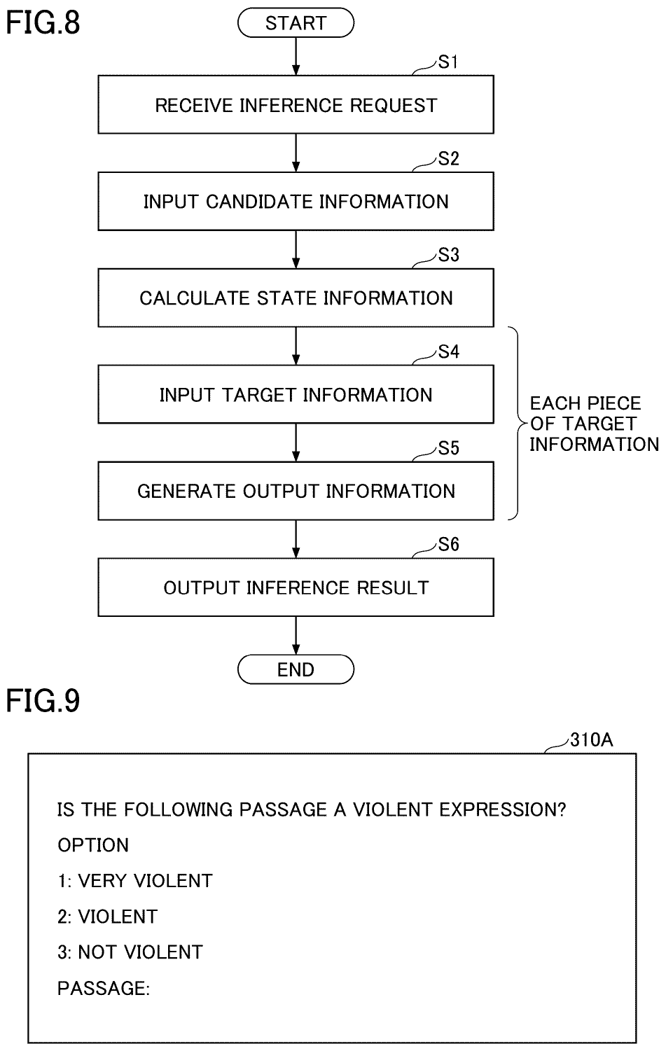

The inference process to be executed by the information processing system 1000 will be described with reference to FIG. 8. FIG. 8 is a flowchart illustrating an example of the inference process according to the first embodiment.

In step S1, the terminal device 50 transmits an inference request to the inference device 10 in response to a user's operation on the input screen 400. The inference request includes candidate information and a plurality of pieces of target information input to the input screen 400.

The request reception unit 110 of the inference device 10 receives the inference request from the terminal device 50. The request reception unit 110 accepts the received inference request. The request reception unit 110 transmits the candidate information, included in the inference request, to the first inference unit 120. The request reception unit 110 transmits the plurality of pieces of the target information, included in the inference request, to the second inference unit 130.

In step S2, the first inference unit 120 of the inference device 10 receives candidate information from the request reception unit 110. The first inference unit 120 generates model input information based on the candidate information. The first inference unit 120 reads out the machine learning model M from the model storage unit 101. The first inference unit 120 inputs, into the machine learning model M, the model input information based on the candidate information.

In step S3, the first inference unit 120 executes the inference process by inputting the model input information into the machine learning model M. Here, the first inference unit 120 calculates intermediate data using the candidate information. The first inference unit 120 stores the calculated intermediate data in the state storage unit 102 (caches the intermediate data).

In step S4, the second inference unit 130 of the inference device 10 receives a plurality of pieces of the target information from the request reception unit 110. The second inference unit 130 obtains a single piece of the target information among the plurality of pieces of the target information. The second inference unit 130 generates model input information based on the obtained target information.

The second inference unit 130 reads out the intermediate data, calculated from the candidate information, from the state storage unit 102. The second inference unit 130 reads out the machine learning model M from the model storage unit 101. The second inference unit 130 inputs, into the machine learning model M, the model input information based on the target information.

In step S5, the second inference unit 130 executes a single inference process using the machine learning model M, and generates output information for the target information. Here, the second inference unit 130 executes the inference process using the intermediate data read out from the state storage unit 102 in step S4. The second inference unit 130 obtains output information from the machine learning model M. The second inference unit 130 transmits the obtained output information to the output unit 140. The second inference unit 130 may not execute, for the target information, a subsequent inference process following the single inference process. The second inference unit 130 may not store the intermediate data calculated in the inference process for the target information (may not cache the intermediate data). As a non-limiting example, the second inference unit 130 may be configured to execute an inference process only once for each piece of the target information.

The second inference unit 130 executes steps S4 and S5 for each of the plurality of pieces of the target information included in the inference request. The second inference unit 130 may execute a batch process of a plurality of pieces of the target information in steps S4 and S5. The second inference unit 130 may repeatedly execute a batch process of a predetermined number of pieces of the target information until output information is generated for all the pieces of the target information.

In step S6, the output unit 140 of the inference device 10 receives output information for the target information from the second inference unit 130. When the output unit 140 receives output information for each of a plurality of pieces of the target information, the output unit 140 generates inference results based on the output information. The output unit 140 transmits the generated inference results to the terminal device 50.

The terminal device 50 receives the inference results from the inference device 10. The terminal device 50 generates the output screen 500 based on the received inference results. The terminal device 50 displays the output screen 500 on the display device.

### Second Embodiment

The output information generated by the inference device 10 according to the first embodiment can be used as training data used for generating other models. In the second embodiment, a configuration of generating other models using the output information generated by the inference device 10 according to the first embodiment will be described. The other models may be machine learning models, such as linear regression, neural networks, and the like, or may be other mathematical models.

In the present embodiment, the request reception unit 110 accepts an inference request including a plurality of pieces of candidate information and a plurality of pieces of target information. First candidate information of the plurality of pieces of the candidate information may include, as an example, an option related to a first evaluation index. Second candidate information different from the first candidate information may include, as an example, an option related to a second evaluation index different from the first evaluation index.

In the present embodiment, the first inference unit 120 calculates intermediate data for each of the plurality of pieces of the candidate information included in the inference request. The second inference unit 130 executes, for each of the plurality of pieces of the target information included in the inference request, an inference process using the intermediate data related to the first candidate information and an inference process using the intermediate data related to the second candidate information. The output unit 140 outputs, for each of the plurality of pieces of the target information, output information including probability values for options related to the first evaluation index and probability values for options related to the second evaluation index.

FIG. 9 is a diagram illustrating a first example of a prompt according to the second embodiment. As illustrated in FIG. 9, a prompt 310A includes a question asking whether or not the target information is violent (“Is the following passage a violent expression?”) and options of an answer to the question (Very violent, Violent, Not violent). In other words, the prompt 310A is model input information including options related to an index for evaluating a level of violence of the target information.

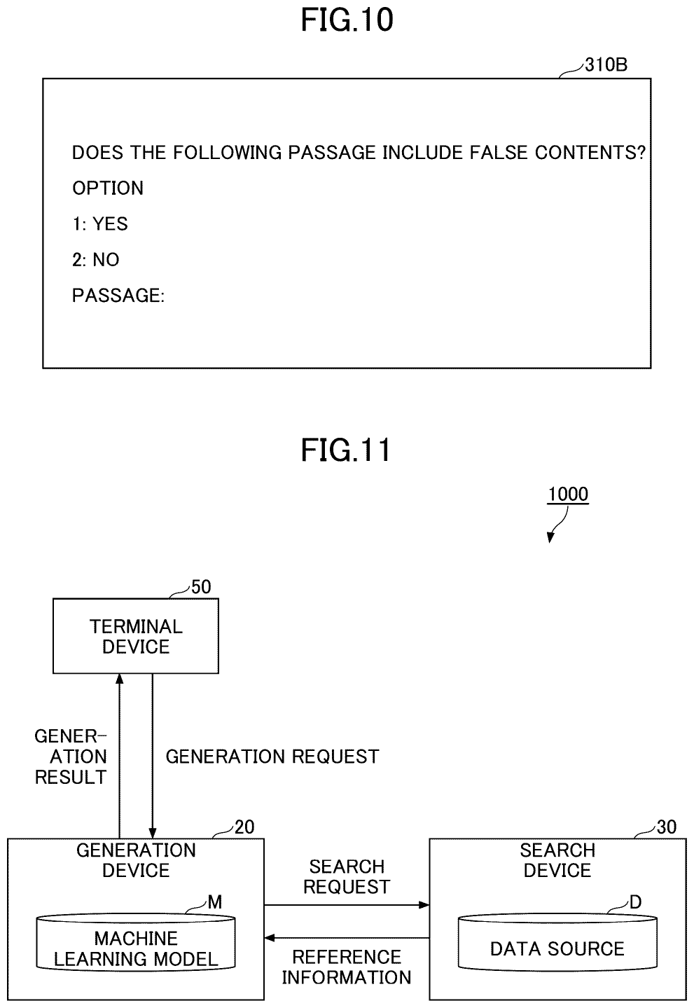

FIG. 10 is a diagram illustrating a second example of the prompt according to the second embodiment. As illustrated in FIG. 10, a prompt 310B includes a question asking whether or not the target information is false (“Does the following passage include false contents?”) and options of an answer to the question (Yes, No). In other words, the prompt 310B is model input information including options related to an index for evaluating a level of trueness of the target information.

The inference device 10 may generate another model based on the output information. As an example, the other model may be a model configured to output probability values of options related to a third evaluation index in response to an input of the probability values of the options related to the first evaluation index and the probability values of the options related to the second evaluation index. The probability value of the option related to the third evaluation index is an example of second output information.

As an example, the information to be input into the other model includes the following information:
Very violent 0.40/Violent 0.15/Not violent 0.45 (first evaluation index); and
Yes 0.5/No 0.5 (second evaluation index).

The information to be output from the other model includes the following information:
Good impression 0.05/Bad impression 0.95.

By assigning ground truth information of the third evaluation index to the output information output by the inference device 10, it is possible to generate training data of the other model. The ground truth information may be obtained from existing evaluation results. When there are no existing evaluation results, the ground truth information may be assigned manually. The ground truth information may be calculated in accordance with a predetermined rule, or may be predicted using the other machine learning model.

As an example, the ground truth information may be calculated according to the following formula:

$$Probability value of “ Good impression ” = sigmoid ( - 2. * Probability value of “ Very violent ” - Probability value of “ Violent ” + 3. * Probability value of “ Not violent ” - Probability value of “ Yes ” + Probability value of “ No ” ) ;$$

$$and$$

$$Probability value of “ Bad impression ” = 1 - Probability value of “ Good impression ” .$$

The other model may be, as an example, a linear regression model. In the present embodiment, the inference device 10 outputs the probability values of the options for each of the evaluation indices, and thus can readily generate a linear regression model. However, the other model is not limited to the linear regression model, and any machine learning model may be generated.

When evaluating an index that can be evaluated by various evaluation axes, an evaluator can evaluate the index by any evaluation axis based on his/her subjectivity. Therefore, if the evaluator subjectively assigns ground truth information, it may be impossible to generate a model configured to stably evaluate the index. According to the inference process according to the present embodiment, it is possible to obtain a plurality of intermediate evaluation results corresponding to a plurality of evaluation axes, and thus generate a model configured to stably evaluate an index that can be evaluated by various evaluation axes.

In the present embodiment, although output information related to the first evaluation index and output information related to the second evaluation index are generated through separate inference processes, output information related to a plurality of evaluation indices may be generated through a single inference process. A configuration of generating output information related to a plurality of evaluation indices through a single inference process will be described in a fourth embodiment.

### Third Embodiment

The inference process according to the first embodiment can be applied to a technique referred to as retrieval augmented generation (RAG). Retrieval augmented generation is a technique of including, in a prompt, reference information obtained by searching for a predetermined data source, in order to obtain good output results from a large language model.

Retrieval augmented generation searches a predetermined data source for reference information based on instruction information that instructs execution of a task, and inputs a prompt, including the instruction information and the search result of the reference information, to a large language model. The large language model executes a task while considering the reference information not included in the training data, and thus can generate data appropriate for the instruction information.

In retrieval augmented generation, it is possible to generate better data as reference information to be included in a prompt is more appropriate for instruction information. However, search accuracy of a data source is greatly different in accordance with a query, a search condition, a type of a data source, a search method, or the like.

In a framework of retrieval augmented generation, the present embodiment evaluates whether or not the reference information is appropriate, by using the inference process according to the first embodiment. By selecting the reference information evaluated as appropriate from the search results of the reference information and including the reference information evaluated as appropriate in a prompt, it is possible to generate data appropriate for the instruction information input by a user.

### <Overall Configuration of Information Processing System>

An overall configuration of the information processing system in the present embodiment will be described with reference to FIG. 11. FIG. 11 is a block diagram illustrating an example of the overall configuration of an information processing system according to the third embodiment.

As illustrated in FIG. 11, the information processing system 1000 includes a generation device 20, a search device 30, and the terminal device 50. The generation device 20, the search device 30, and the terminal device 50 may be connected to one another through a communication network, such as a local area network (LAN), the Internet, or the like, so as to enable data communication.

The generation device 20 is an example of an information processing device, such as a personal computer, a work station, a server, or the like, that is configured to execute a generation task to generate predetermined data in response to a generation request from the terminal device 50. The generation device 20 may receive a generation request from the terminal device 50. The generation device 20 may transmit a generation result for the generation request to the terminal device 50.

The generation request is information or a signal requesting generation of predetermined data. The generation request may include information input by a user and search conditions set by the user. Hereinafter, the information input by the user may be referred to as “user input information”.

The generation device 20 may obtain the search results of reference information from the search device 30 based on the generation request received from the terminal device 50. The generation device 20 may transmit the search request to the search device 30 based on the generation request.

The search request is information or a signal requesting search of reference information. The search request may include, as an example, a query and a search condition. The query may include the user input information included in the generation request. The query may be generated based on the user input information. The search condition may include a search condition included in the generation request. The search condition may be determined based on the user input information.

The generation device 20 may generate model input information based on the search result of the reference information obtained from the search device 30. The generation device 20 may generate output information for each piece of the reference information included in the search result by inputting the model input information into the machine learning model M. The generation device 20 may select one or more pieces of reference information for use in generation of the output information for the generation request based on the output information for each of the plurality of pieces of the reference information.

The generation device 20 may generate the model input information based on the user input information and the one or more selected pieces of reference information. The generation device 20 may generate output information for the generation request by inputting the model input information into the machine learning model M. The generation device 20 may generate output information for the generation request by inputting the model input information to the other machine learning model. The output information for the generation request is an example of third output information. The generation device 20 may transmit the generation result for the generation request to the terminal device 50 based on the output information for the generation request.

The search device 30 is an example of an information processing device, such as a personal computer, a work station, a server, or the like, that is configured to search for reference information in response to a search request from the generation device 20. The search device 30 may include a data source D that stores various reference information. The data source D may be, as an example, a storage device or database in which reference information is stored. The data source D may be included in an external storage device, an external information processing device, or an external information processing system.

The search device 30 may be realized by a plurality of devices or systems including different data sources D. The search device 30 may be realized by a single device or system including a plurality of data sources D. The search device 30 may be an external device or system. The search device 30 may search an external data source D for reference information.

The data source D may be included in the generation device 20. The data source D may be separately included in an external information processing system including a plurality of devices. In this case, the information processing system 1000 may not include the search device 30.

At least one of the generation device 20, the search device 30, or the terminal device 50 may be included in two or more in the information processing system 1000. The generation device 20 or the search device 30 may be realized by a plurality of computers, or may be realized as a cloud computing service. The segmentation of devices illustrated in FIG. 11, like the generation device 20, the search device 30, and the terminal device 50, is merely an example.

### <Functional Configuration of Generation Device>

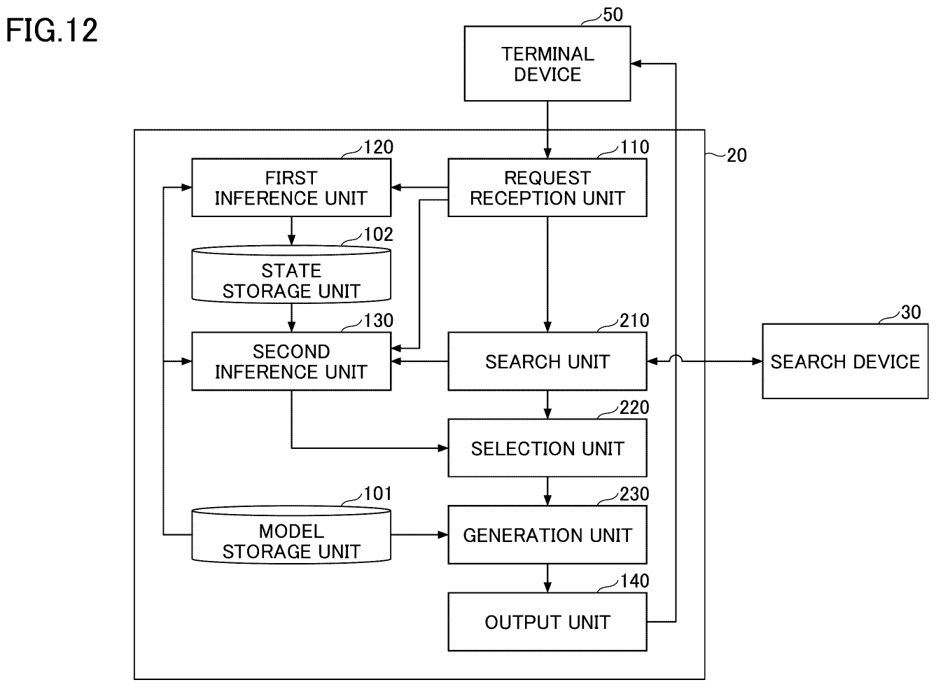

A functional configuration of the generation device 20 will be described with reference to FIG. 12. FIG. 12 is a block diagram illustrating an example of the functional configuration of the generation device according to the third embodiment.

As illustrated in FIG. 12, the generation device 20 includes the model storage unit 101, the state storage unit 102, the request reception unit 110, the first inference unit 120, the second inference unit 130, the output unit 140, a search unit 210, a selection unit 220, and a generation unit 230. The generation device 20 differs from the inference device 10 according to the first embodiment in that the generation device 20 further includes the search unit 210, the selection unit 220, and the generation unit 230.

Hereinafter, differences of the generation device 20 according to the present embodiment from the inference device 10 according to the first embodiment will be mainly described.

In the present embodiment, the request reception unit 110 is configured to accept a generation request. The generation request may include the user input information and the search condition. The user input information and the search condition may be input to the terminal device 50 by a user, or may be automatically generated by the generation device 20 or the terminal device 50.

The user input information may include search terms to be included in a query. The user input information may include information that can specify information desired by the user. The user input information may include one or more natural language sentences describing information desired by the user. The user input information may include, as an example, instructions, questions, and the like, such as “Please provide me with an overview of Company A.” or “Please create a summary of news on recent generative AI (artificial intelligence).”.

The user input information may include text data, structured data, image data, or acoustic data. The image data may be, as an example, a still image or a video. The text data may be text data obtained through voice recognition of acoustic data or a video. The text data may be text obtained through character recognition of image data. The acoustic data may be voice data obtained through voice synthesis of text data. The structured data may be, as an example, a table or a graph.

The search condition may include, as an example, at least one of information indicating a data source to be searched for, a type of the data source, a time range of creation date, attribute information of reference information to be searched for, or the number of results to be included in a search result.

The information indicating the data source may be information that can specify the data source. The information that can specify the data source may be, as an example, identification information identifying the data source, or information indicating the location of the data source (e.g., a host name, an IP (Internet Protocol) address, a connection string, URL (Uniform Resource Locator), or the like).

The search unit 210 is configured to search for reference information based on the generation request received by the request reception unit 110. As an example, the search unit 210 may transmit, to the search device 30, the search request including the user input information included in the generation request. The search unit 210 may receive the search result transmitted by the search device 30 in response to the search request. The search result may include a plurality of pieces of reference information matching the search condition indicated in the search request.

The search request may include at least one of a query or a search condition. The query may be generated based on the user input information included in the generation request. As an example, the query may include a keyword included in the user input information. The search condition may include the search condition included in the generation request. The search condition may include a predetermined search condition. The search condition may be determined based on the user input information included in the generation request.

The search unit 210 may search for reference information from a plurality of data sources indicated in the search condition. The search unit 210 may include, in the search result, pieces of reference information in the number indicated in the search condition. The search unit 210 may include, in the search result, the predetermined number of pieces of reference information. The search unit 210 may set the number of pieces of reference information to be included in the search result in accordance with the amount of data that can be input into the machine learning model M. The number of pieces of reference information may be, as an example, 10,000.

In the present embodiment, the first inference unit 120 is configured to generate candidate information based on the generation request accepted by the request reception unit 110. The first inference unit 120 may generate candidate information based on the user input information included in the generation request.

The candidate information may include, as an example, a question asking whether or not the reference information obtained by the search unit 210 is appropriate for the user input information. The candidate information may include, as an example, an option related to an index for evaluating a level of appropriateness of the reference information.

In the present embodiment, the second inference unit 130 is configured to generate output information for each of the plurality of pieces of the reference information included in the search result obtained by the search unit 210, based on the intermediate data calculated by the first inference unit 120 and the machine learning model M stored in the model storage unit 101. The second inference unit 130 may read out the intermediate data stored in the state storage unit 102, and generate output information for the reference information by inputting, into the machine learning model M, one of the plurality of pieces of the reference information included in the search result, and the intermediate data. The second inference unit 130 may generate, in parallel, pieces of output information for two or more of the plurality of pieces of the reference information.

The second inference unit 130 may divide a single piece of reference information into a plurality of portions, and input the divided portions into the machine learning model M. The second inference unit 130 may generate, in parallel, pieces of output information for the plurality of the divided portions. As an example, the second inference unit 130 may divide reference information in a unit of a single sentence, a predetermined number of sentences, a predetermined number of characters, one or more paragraphs, or one or more chapters. The second inference unit 130 may divide reference information such that divided portions of the reference information overlap with each other. When the reference information is multimodal data, the second inference unit 130 may divide the reference information in units of text data, image data, voice data, or the like.

The selection unit 220 is configured to, based on the output information generated by the second inference unit 130, select one or more pieces of reference information for use in generation of output information for the generation request from the search result of the reference information obtained by the search unit 210. The selection unit 220 may obtain information that can specify the reference information. The information that can specify the reference information may be, as an example, identification information identifying the reference information, or information indicating the location of a file in which the reference information is described.

The selection unit 220 may select reference information in which a probability value for a predetermined option is equal to or higher than a predetermined threshold. The selection unit 220 may select a predetermined number of pieces of reference information in accordance with an order of the highest probability value for a predetermined option. The predetermined number may be, as an example, 10. The predetermined option may be, as an example, an option indicating that the reference information is appropriate.

The generation unit 230 is configured to generate output information for the generation request, based on the generation request accepted by the request reception unit 110 and one or more pieces of reference information selected by the selection unit 220. The generation unit 230 may generate, as an example, model input information based on the generation request and the reference information.

The generation unit 230 may generate model input information by using at least a portion of the information included in one or more pieces of the reference information selected by the selection unit 220. The generation unit 230 may generate model input information by using information obtained by processing the reference information. The generation unit 230 may generate model input information by using at least a portion of the information included in the user input information. The generation unit 230 may generate model input information by using the information obtained by processing the user input information.

The generation unit 230 may generate model input information by embedding, in a predetermined template, the user input information and one or more selected pieces of reference information. The generation unit 230 may generate the model input information by processing the template, the user input information, and the reference information in accordance with a predetermined rule. The generation unit 230 may generate the model input information by inputting the template, the user input information, and the reference information into the machine learning model M or the other machine learning model.

The template for generating the model input information may include one or more placeholders in which the user input information or one or more pieces of the reference information selected by the selection unit 220 are to be embedded. The template may include instruction information for instructing generation of output information for the generation request. The template may include constraint information related to output information for the generation request. The instruction information and the constraint information may be predetermined fixed sentences.

The generation unit 230 may generate output information for the generation request by inputting the model input information into the machine learning model M. The generation unit 230 may generate output information for the generation request by inputting the model input information to the other machine learning model different from the machine learning model M. The generation unit 230 may generate output information for the generation request by inputting the model input information to a single machine learning model selected from a plurality of machine learning models. The machine learning model for use in generation of output information for the generation request may be, as an example, designated by the generation request. The machine learning model designated by the generation request may be selected by a user.

The output unit 140 is configured to output the generation result for the generation request accepted by the request reception unit 110, based on the output information for the generation request generated by the generation unit 230. The output unit 140 may transmit, to the terminal device 50, the generation result including the output information for the generation request. The output unit 140 may display, on the display device of the generation device 20, the generation result including the output information for the generation request.

The generation result may include text data, image data, or acoustic data. The text data may be, as an example, a natural language sentence. The image data may be, as an example, a still image or a video. The text data may be text data obtained through voice recognition of acoustic data or voice data recorded in a video. The text data may be text obtained through character recognition of an image data. The acoustic data may be voice data obtained through voice synthesis of text data.

### <Prompt>

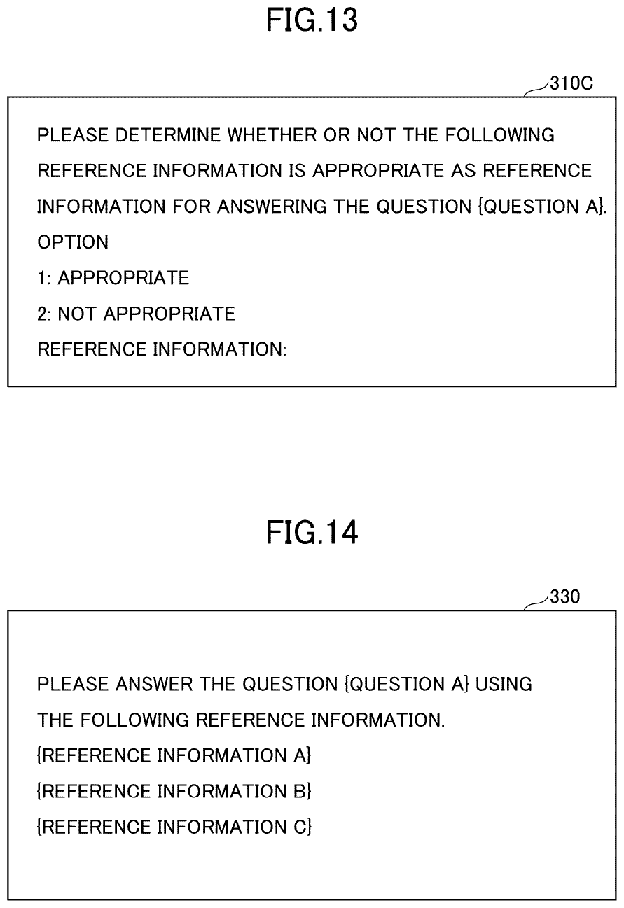

A prompt, which is an example of the model input information according to the third embodiment, will be described with reference to FIGS. 13 and 14.

FIG. 13 is a diagram illustrating a first example of the prompt according to the third embodiment. A prompt 310C illustrated in FIG. 13 is an example of the model input information input by the first inference unit 120 into the machine learning model M.

As illustrated in FIG. 13, the prompt 310C includes a question asking whether or not the user input information (Question A) is appropriate (“Please determine whether or not the following reference information is appropriate as reference information for answering the question {Question A}”). The prompt 310C includes options (Appropriate, Not appropriate, or the like) related to an index for evaluating a level of appropriateness of the reference information. Note that {Question A} is a placeholder in which the user input information is to be embedded.

FIG. 14 is a diagram illustrating a second example of the prompt according to the third embodiment. A prompt 330 illustrated in FIG. 14 is an example of model input information that is input by the generation unit 230 into the machine learning model M or the other machine learning model.

As illustrated in FIG. 14, the prompt 330 includes a generation instruction using the user input information (Question A) (“Please answer the question {Question A} using the following reference information.”). The prompt 330 includes reference information selected by the selection unit 220 (Reference information A, Reference information B, Reference information C). Note that {Question A} is a placeholder in which the user input information is to be embedded. {Reference information A}, {Reference information B}, and {Reference information C} are placeholders in which the reference information is to be embedded.

### <Flow of Generation Process>

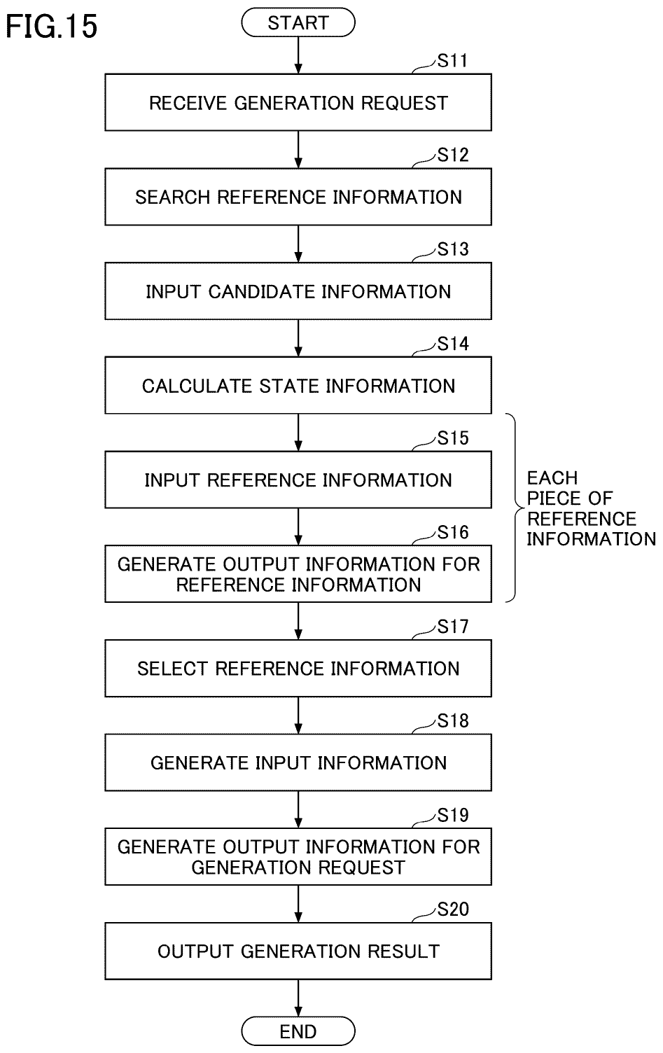

A generation process executed by the information processing system 1000 will be described with reference to FIG. 15. FIG. 15 is a flowchart illustrating an example of the generation process according to the third embodiment.

In step S11, the terminal device 50 transmits a generation request to the generation device 20 in response to a user's operation. The generation request includes user input information. The generation request may include a search condition.

The request reception unit 110 of the generation device 20 receives the generation request from the terminal device 50. The request reception unit 110 accepts the received generation request. The request reception unit 110 transmits, to the search unit 210, the user input information and the search condition. The request reception unit 110 transmits the user input information to the first inference unit 120 and the generation unit 230.

In step S12, the search unit 210 of the generation device 20 receives the user input information and the search condition from the request reception unit 110. The search unit 210 transmits a search request to the search device 30 based on the user input information and the search condition. The search request includes a query and a search condition set based on the user input information.

The search device 30 receives the search request from the generation device 20. The search device 30 searches for reference information satisfying the search condition from the data source D based on the search request. The search device 30 transmits the search result of the reference information to the generation device 20. The search device 30 may search for reference information by any method based on the search request.

The search unit 210 of the generation device 20 receives the search result of the reference information from the search device 30. The search unit 210 transmits the search result of the reference information to the second inference unit 130 and the selection unit 220.

In step S13, the first inference unit 120 of the generation device 20 receives the user input information from the request reception unit 110. The first inference unit 120 generates candidate information based on the user input information. The first inference unit 120 generates model input information based on the candidate information. The first inference unit 120 reads out the machine learning model M from the model storage unit 101. The first inference unit 120 inputs, into the machine learning model M, the model input information based on the candidate information.

In step S14, the machine learning model M executes an inference process using the input model input information. The machine learning model M calculates intermediate data using the candidate information. The first inference unit 120 obtains the intermediate data generated by the machine learning model M. The first inference unit 120 stores (caches) the obtained intermediate data in the state storage unit 102.

In step S15, the second inference unit 130 of the generation device 20 receives the search result of the reference information from the search unit 210. The second inference unit 130 obtains a single piece of the reference information among a plurality of pieces of the reference information included in the search result. The second inference unit 130 generates the model input information based on the obtained reference information.

The second inference unit 130 reads out the cached intermediate data from the state storage unit 102. The second inference unit 130 reads out the machine learning model M from the model storage unit 101. The second inference unit 130 inputs, into the machine learning model M, the intermediate data corresponding to the candidate information and the model input information based on the reference information. The second inference unit 130 may execute an inference process by inputting the model input information to the other machine learning model different from the machine learning model M.

In step S16, the machine learning model M executes an inference process using the input model input information. The machine learning model M generates output information for the reference information. The second inference unit 130 obtains the output information generated by the machine learning model M. The second inference unit 130 transmits the obtained output information to the selection unit 220. The second inference unit 130 may generate output information by performing a single inference process for the reference information.

The second inference unit 130 executes steps S15 and S16 for each of the plurality of pieces of the reference information included in the search result of the reference information. The second inference unit 130 may execute a batch process of the plurality of pieces of the reference information in steps S15 and S16. The second inference unit 130 may repeatedly execute a batch process of a predetermined number of pieces of the reference information until output information is generated for all pieces of the reference information.

In step S17, the selection unit 220 of the generation device 20 receives the search result of the reference information from the search unit 210. The selection unit 220 receives output information for the reference information from the second inference unit 130. When the selection unit 220 receives output information for each of the plurality of pieces of the reference information, the selection unit 220 selects reference information for use in generation of output information for the generation request from the search result of the reference information based on the output information. The selection unit 220 transmits the selected reference information to the generation unit 230. Here, the selection unit 220 may select reference information for use in generation of output information for the generation request based on the probability value for a predetermined option included in the output information.

In step S18, the generation unit 230 of the generation device 20 receives the user input information from the request reception unit 110. The generation unit 230 receives the selected reference information from the selection unit 220. The generation unit 230 generates model input information based on the user input information and the selected reference information.

In step S19, the generation unit 230 of the generation device 20 reads out the machine learning model M from the model storage unit 101. The generation unit 230 inputs, into the machine learning model M, the model input information generated in step S18.

The machine learning model M executes a predetermined task (generation process or the like) based on the input model input information, and generates output information for the generation request. The generation unit 230 obtains the output information for the generation request from the machine learning model M. The generation unit 230 transmits the obtained output information for the generation request to the output unit 140.

In step S20, the output unit 140 of the generation device 20 receives the output information for the generation request from the generation unit 230. The output unit 140 generates a generation result based on the output information for the generation request. The output unit 140 transmits the generated generation result to the terminal device 50.

The terminal device 50 receives the generation result from the generation device 20. The terminal device 50 displays the received generation result on a display device. The generation result may include a portion of the output information generated by the generation unit 230, or may include information generated based on the output information.

### Fourth Embodiment

In the first embodiment, as an example, the configuration of generating, as output information, one token that can be generated through a single inference process has been described. In the fourth embodiment, a configuration of generating output information related to a plurality of tokens through a single inference process is described. According to the present embodiment, for example, output information related to a plurality of evaluation indices indicated in the second embodiment can be generated through a single inference process.

In the present embodiment, as an example, a classification task to classify a plurality of pieces of target information into an option related to a first classification and an option related to a second classification is executed. In the present embodiment, the option related to the first classification includes Options A, B, and C, and the option related to the second classification includes Options D and E. Therefore, the output information generated by the inference device 10 may include probability values of AD, AE, BD, BE, CD, and CE for each of the plurality of pieces of the target information. Here, AD means that Option A is selected for the first classification and Option D is selected for the second classification.

In the present embodiment, candidate information may include information that explicitly instructs an answering method. As an example, the candidate information may include information that instructs to successively output Option A, B, or C for the first classification and Option D or E for the second classification. The information that instructs the answering method may be a predetermined fixed sentence.

In the present embodiment, the above classification task may be realized by inputting an attention mask into the machine learning model M. The attention mask is information that masks references to some tokens.

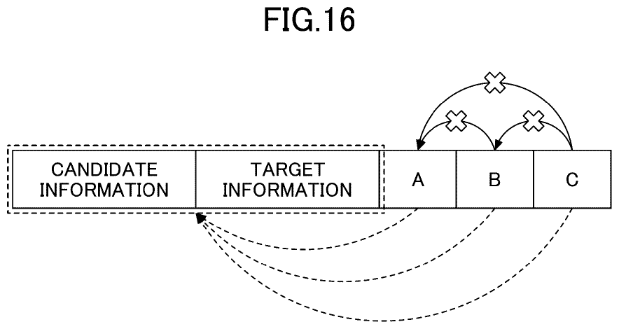

FIG. 16 is a diagram describing an example of an attention mask. As illustrated in FIG. 16, candidate information, target information, and Options A, B, and C related to the first classification are input into the machine learning model M. The candidate information may be intermediate data (key value cache) calculated using the candidate information. The attention mask is set such that A, B, and C each refer to only the candidate information and the target information.

Specifically, the attention mask is set as follows:
A refers to all the past tokens (Candidate information, Target information);
B refers to the past tokens (Candidate information, Target information) excluding Option A; and
C refers to the past tokens (Candidate information, Target information) excluding Options A and B.

The next token for A is inferred through a forward process using “Candidate information, Target information, A”. The next token for B is inferred through a forward process using “Candidate information, Target information, B”. The next token for C is inferred through a forward process using “Candidate information, Target information, C”. As a result, probability information for each of AD, AE, BD, BE, CD, and CE can be generated through a single inference process.

When setting the attention mask illustrated in FIG. 16, positional embedding may be changed. However, even if positional embedding is not changed, satisfactory results can be obtained approximately.

Here, the configuration of generating output information for two tokens through a single inference process has been described. However, output information for three or more tokens may be generated. As an example, a configuration of generating output information for three tokens will be described.

The options related to the first classification include Options A, B, and C, the options related to the second classification include Options D and E, and the options for the third classification include Options F and G. Therefore, the inference result output by the inference device 10 may include probability information for ADF, ADG, AEF, AEG, BDF, BDG, BEF, BEG, CDF, CDG, CEF, and CEG for each of a plurality of pieces of target information.

Information in which a token string, ADAEBDBECDCE, is added to the end of target information is input into the machine learning model M. An attention mask is set as follows:
the first token A refers to all the past tokens (Candidate information, Target information);
the second token D refers to all the past tokens (Candidate information, Target information, A);
the third token A refers to the past tokens (Candidate information, Target information) excluding AD;
the fourth token E refers to the past tokens (Candidate information, Target information, A) excluding AD;
the fifth token B refers to the past tokens (Candidate information, Target information) excluding ADAE;
the sixth token D refers to the past tokens (Candidate information, Target information, B) excluding ADAE;
the seventh token B refers to the past tokens (Candidate information, Target information) excluding ADAEBD;
the eighth token E refers to the past tokens (Candidate information, Target information, B) excluding ADAEBD;
the ninth token C refers to the past tokens (Candidate information, Target information) excluding ADAEBDBE;
the tenth token D refers to the past tokens (Candidate information, Target information, C) excluding ADAEBDBE;
the eleventh token C refers to the past tokens (Candidate information, Target information) excluding ADAEBDBECD; and
the twelfth token E refers to the past tokens (Candidate information, Target information, C) excluding ADAEBDBECD.

When generating output information for three tokens, the machine learning model M executes a single inference process using information in which N_1*N_2*2 tokens are added to the end of the target information. Here, N_1 is the number of options for the first classification, and N_2 is the number of options for the second classification.

Generalizing this, when generating output information for K tokens, the machine learning model M executes a single inference process using information in which N_1* . . . *N_K−1*(K−1) tokens are added to the end of the target information. Here, K is an integer of two or more, and N_K−1 is the number of options for the K−1^{th} classification.

Although an example of answering options has been described here, the present embodiment can be applied to any task to generate output information that can be represented by two or more tokens. As an example, the information that can be represented by two or more tokens is a number from 0000 to 9999. Therefore, the present embodiment is not limited to the task to perform classification or answer options, and can be applied to any task.

### <User Interface>

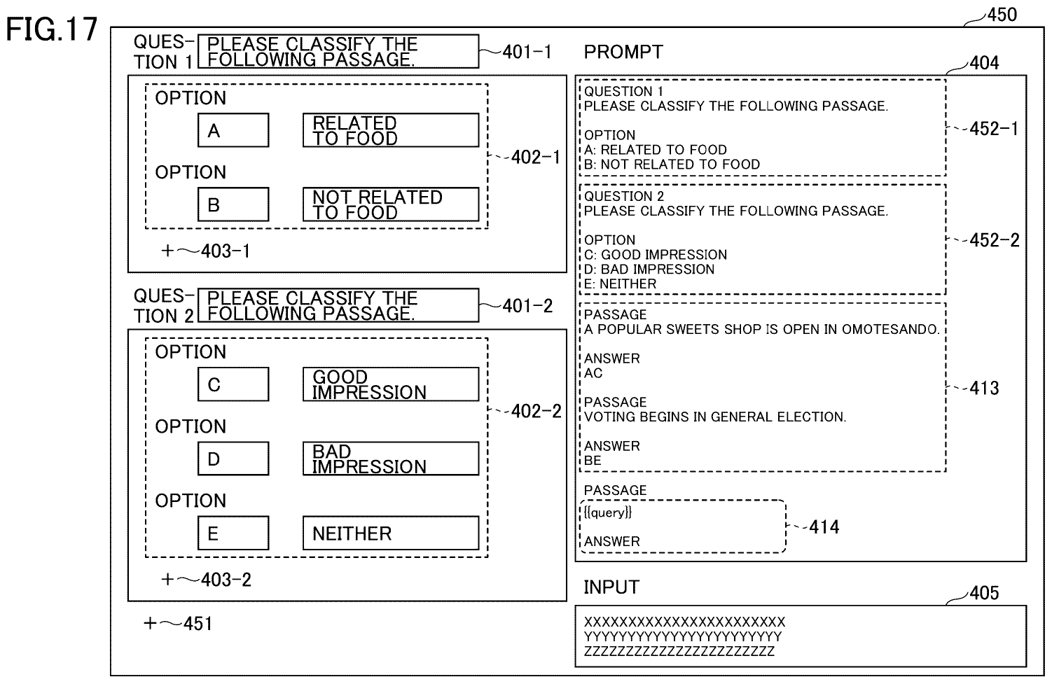

FIG. 17 is a diagram illustrating an example of an input screen according to the fourth embodiment. Here, differences from the input screen 400 according to the first embodiment (see FIG. 6) will be mainly described.

As illustrated in FIG. 17, an input screen 450 may include a plurality of question input fields 401 (401-1, 401-2), a plurality of option input fields 402 (402-1, 402-2), a plurality of option addition buttons 403 (403-1, 403-2), an input information display field 404, a target information input field 405, and a question addition button 451.

The question addition button 451 is a button configured to add a new question and a new option to the input screen 450. When a user presses the question addition button 451, the question input field 401 and the option input field 402 are added to the input screen 450. Although the same question is input to the option input field 402-1 and the option input field 402-2, different questions may be input.

The input information display field 404 is configured to display model input information including a plurality of questions and a plurality of options input to the question input field 401 and the option input field 402. The model input information displayed on the input information display field 404 includes a set of a question and options 452-1 and a set of a question and options 452-2. The set of a question and options 452-1 includes the question and options corresponding to the question input field 401-1 and the option input field 402-1. The set of a question and options 452-2 includes the question and options corresponding to the question input field 401-2 and the option input field 402-2.

The input information display field 404 may automatically generate the model input information based on information input to the question input fields 401-1 and 401-2 and the option input fields 402-1 and 402-2. The input screen 450 may include a button configured to generate the model input information to be displayed on the input information display field 404. The input information display field 404 may display the model input information in a form that is editable by a user with a text editor or the like.

When candidate information including a plurality of questions and options are included in the inference request, the inference process according to the present embodiment may generate output information including answers to each question through a single inference process. In the input screen 450, the reference answer information 413 included in the input information display field 404 may include answers that can be represented by two tokens.

In the present embodiment, the same inference results as in the output screen 500 according to the first embodiment (see FIGS. 7A to 7D) may be displayed for each of the plurality of questions input to the question input fields 401-1 and 401-2. That is, for each of the plurality of questions, the output screen 500 according to the present embodiment may display the probability value for each option, the option having the highest probability value, or the option having the highest probability value and the probability value of this option. The output screen 500 according to the present embodiment may display options arranged in a descending or ascending order of probability value for each of the plurality of questions.

### First Another Embodiment

Although numbers, characters, symbols, and the like are used as the identification information of the options in the above embodiments, special tokens may be used as the identification information of the options. The special tokens are tokens that are not associated with specific character strings. As an example, the special tokens may be tokens, such as, for example, <choice 1>, <choice 2>, . . . .

In order to use such special tokens, the machine learning model M may perform pre-learning by replacing training data including options with special tokens. In an inference process using the machine learning model M, when generating model input information, the identification information of the options included in the candidate information may be replaced with special tokens. By using the special tokens as the identification information of the options, it is possible to generate output information that is not influenced by a bias of numbers, characters, symbols, and the like used for the identification information.

In the above embodiments, the intermediate data is calculated by inputting the candidate information into the machine learning model, and a predetermined number of pieces of the target information are batch-processed using the intermediate data corresponding to the candidate information. By inputting, into the machine learning model, a single piece of the target information along with the candidate information, and executing an inference process, output information corresponding to the target information along with the intermediate data corresponding to the candidate information may be generated.

Specifically, the batch process may be executed in the following configuration. In the first batch process, the batch size is set to 1, and the candidate information and a single piece of the target information are input into the machine learning model. The machine learning model outputs intermediate data corresponding to the candidate information and output information corresponding to the target information. In the second and subsequent batch processes, the batch size is set to a large value, and the target information corresponding to the batch size is batch-processed using the intermediate data calculated in the first batch process. Subsequently, the batch process is repeatedly executed in a large batch size until output information is generated for all the pieces of the target information.

In the above embodiments, as an example, before executing an inference process for each of a plurality of pieces of the target information, intermediate data is cached by executing an inference process in which the candidate information is input into the machine learning model M, and an inference process for each of the plurality of pieces of the target information is executed by using the cached intermediate data. As another embodiment, the second inference unit 130 may execute an inference process for the target information by linking at least a portion of the candidate information to the target information, and inputting the linked information into the machine learning model M as input information. In this case, the information processing system 1000 does not necessarily need to execute, in advance, calculation of the intermediate data using the candidate information. That is, the information processing system 1000 may have a configuration that does not have the functions of the first inference unit 120 and the state storage unit 102.

As an example, the second inference unit 130 may generate output information by inputting, into the machine learning model M, the following prompt in which the candidate information 310 illustrated in FIG. 3 is linked to the target information (“I went to this restaurant but it was horrible”).

Prompt:
“Please determine your impression about the following passage.
Options:
1: Good impression
2: Bad impression
3: Neither
Passage:
I went to this restaurant but it was horrible.”

This prompt includes information (at least a portion of the candidate information) requesting the generation of information that can be generated through a single inference process using the machine learning model M (e.g., one token). Thus, the information processing system 1000 can generate probability information for options by executing a single inference process. Here, the second inference unit 130 can omit the execution of the inference process following the single inference process. Thus, it is not necessary to cache intermediate data (key vectors, value vectors), calculated in the execution process of the single inference process, for the execution of the subsequent inference process. The information processing system 1000 may batch-process each of the plurality of pieces of the target information linked to at least a portion of the candidate information by using a similar technique. The information processing system 1000 can omit the cache process for the candidate information and the target information. Thus, it is possible to generate output information for each of the plurality of pieces of the input information with a small amount of memory usage. The information processing system 1000 may include reference answer information in the input information (prompt) as in the above embodiments.

When the target information includes information requesting the generation of information that can be generated through a single inference process using the machine learning model M (e.g., one token), the linking process of at least a portion of the candidate information may not be executed. An example of the input information (prompt) in this case is as follows.

### Example 1

“Please answer, what is the number of days in a week.”

The input information in the present embodiment may be information in which at least a portion of the candidate information is linked to the target information, or may be the target information including information requesting the generation of information that can be generated through a single inference process using the machine learning model M (e.g., one token). The input information may further include reference answer information. The information processing system 1000 may execute a single inference process for each of a plurality of pieces of input information. In this case, an inference process may be executed in parallel using a batch process. Also, the information processing system 1000 may be set not to execute an inference process following the single inference process for each of the plurality of pieces of input information. The information processing system 1000 may be set to execute only the single inference process for each of the plurality of pieces of input information. The information processing system 1000 may not cache intermediate data calculated by executing an inference process for each of the plurality of pieces of input information. The input information may include text data, image data, or acoustic data.

In the above embodiments, as an example, output information for each piece of the input information is generated by executing a single inference process for each of the plurality of pieces of the input information (including the target information and the reference information). Here, the single inference process may be a single output-information-generation process included in a process of inputting the input information into the machine learning model and generating output information (tokens or the like) autoregressively a plurality of times. A non-limiting example of the single inference process may be a generation process of one token.

In the above embodiments, as an example, the information processing system 1000 executes a task to determine how good or bad the impression on a message posted on a social networking service is. However, the task executed by the information processing system 1000 is not limited to the above.

The other examples of the generation task include a task to extract specific topic-related items from news articles, a task to analyze whether or not posts about a specific product are favorable in a social networking service, a task to extract unsatisfactory reviews posted about a specific product in a mail order service, a task to perform filtering of reviews posted about a specific defect in a specific product, a task to perform filtering of training data for a machine learning model, such as a foundation model or the like, marketing analysis for analyzing users' reputation or feedback from users, a task to extract necessary data from big data, a task to remove noise from big data, and the like.

In the above embodiments, the inference device 10 accepts an input of the candidate information and the target information through a user interface, and presents the inference result for the target information to a user. The inference device 10 may provide an input of at least one of the candidate information or the target information, an output of the output information for the target information, and the like, through an application programming interface (API). The API may be a Web API provided via the Web.

In the above embodiments, a configuration using a decoder-only large language model has been described as an example of the machine learning model M. However, the machine learning model M is not limited to a decoder-only large language model. The machine learning model M may be any machine learning model that can reduce a calculation cost by using a cache.

The information processing system 1000 may periodically repeatedly execute the same task. As an example, the information processing system 1000 may execute the same task a plurality of times at different points in time for the same target to be processed. The information processing system 1000 may execute the same task once for each of different targets to be processed. In this case, the candidate information retained by the inference device 10 may be used without obtaining the candidate information from the terminal device 50 every time the task is executed.

The information processing system 1000 can execute classification or analysis of a large amount of data. As an example, the information processing system 1000 may generate a prompt including a modal of an image, and generate output information that evaluates whether or not the image is similar to the target information. The information processing system 1000 may perform filtering of the target information based on the output information. With the above configuration, classification or analysis of a large amount of data can be executed without additional training of the machine learning model. In other words, the information processing system 1000 can execute classification or filtering of a large amount of data without pre-training by using knowledge already learned by the machine learning model.

The information processing system 1000 can construct various classifiers only by changing a prompt. As an example, the information processing system 1000 may execute class classification by Few-shot prompting.

All the configurations related to the information processing system 1000 according to each of the above embodiments can be applied to the information processing system 1000 according to another embodiment. As an example, the configurations related to the information processing system 1000 according to the second to fourth embodiments can be applied to the information processing system 1000 according to the first embodiment. The configurations related to the information processing system 1000 according to the third or fourth embodiment can be applied to the information processing system 1000 according to the second embodiment. The configurations related to the information processing system 1000 according to the fourth embodiment can be applied to the information processing system 1000 according to the third embodiment.

### CONCLUSION

As is clear from the above description, the information processing system 1000 according to the embodiments of the present disclosure obtains information related to output candidates and a plurality of pieces of target information, and calculates first intermediate data by inputting the information related to the output candidates into a machine learning model. Using at least a portion of the first intermediate data, the information processing system 1000 generates output information for each of the plurality of pieces of the target information by executing a single inference process using the machine learning model on each of the plurality of pieces of the target information.

The information related to the output candidates may include identification information of options. The identification information of options may be information that can be represented by using information that can be generated through a single inference process. The information related to the output candidates may include options. The options may be information that can be represented by using information that can be generated through a single inference process. The information related to the output candidates may include information that requests the generation of numbers. The numbers may be information that can be represented by using information that can be generated through a single inference process. The information related to the output candidate may include information requesting the generation of information that can be generated through a single inference process.

The information processing system 1000 may not store at least a portion of the second intermediate data, calculated by executing the single inference process for the target information, for an inference process for the target information after the single inference process using the machine learning model. Not to store at least a portion of the second intermediate data may include not to cache at least a portion of the second intermediate data by at least one processor. At least a portion of the second intermediate data may include at least a portion of key vectors and value vectors used in the attention mechanism of the machine learning model.

The information processing system 1000 may cache at least a portion of the first intermediate data and use the cached at least the portion of the first intermediate data, thereby executing a single inference process using the machine learning model for each of the plurality of pieces of the target information. At least a portion of the first intermediate data may include at least a portion of key vectors and value vectors used in the attention mechanism of the machine learning model.

The information processing system 1000 may not execute an inference process for the target information after the single inference process. The information processing system 1000 may generate output information for each of two or more pieces of the target information in parallel.

The information related to the output candidate may include at least information related to the first classification and information related to the second classification. In a single inference process, the information processing system 1000 may input, into the machine learning model, information in which the target information is linked to the token for an option of the first classification. The token for the option may be linked after the target information. The token for the option may include at least a token for a first option related to a first classification, and a token for a second option related to the first classification. The token for the second option is linked after the token for the first option. In a single inference process, the token for the second option may be set not to refer to the token for the first option.

The information processing system 1000 may learn another model based on the output information for each of the plurality of pieces of the target information, and the ground truth information. The information processing system 1000 may generate second output information for each of the plurality of pieces of the target information by inputting, in another model, the output information for each of the plurality of pieces of the target information.

The information processing system 1000 may select one or more pieces of target information for use in generation of the third output information based on the output information for each of the plurality of pieces of the target information. The information processing system 1000 may generate input information to be input to at least one of the machine learning model or the other machine learning model based on the generation request and the one or more pieces of the target information. The information processing system 1000 may generate the third output information by inputting the input information to at least one of the machine learning model or the other machine learning model. The information related to the output candidates may be information generated based on the generation request. The plurality of pieces of the target information may be information obtained through search based on a predetermined search condition. The predetermined search condition may be determined based on the generation request.

The terminal device 50 may display, on a display device, the information for obtaining the information related to the output candidates; display, on the display device, the information for obtaining a plurality of pieces of the target information; and display, on the display device, the inference result based on the output information for each of the plurality of pieces of the target information. The output information for each of the plurality of pieces of the target information may be information generated by executing a single inference process using the machine learning model for each of the plurality of pieces of the target information by using at least a portion of the intermediate data calculated by inputting the information related to the output candidates into the machine learning model.

The terminal device 50 may obtain information related to options from a user, and generate information related to output candidates based on the information related to the options. The information related to the options may include at least one of: identification information of the options that can be represented by using information that can be generated through a single inference process; or the options that can be represented by using information that can be generated through a single inference process. The inference result may include at least one of: probability values of the options; options selected based on probability information included in the output information; or information based on the selected options. The terminal device 50 may obtain a plurality of pieces of target information from an electronic file designated by a user.

The information processing system 1000 may obtain a plurality of pieces of input information, and generate output information for each of the plurality of pieces of the input information by executing a single inference process using the machine learning model for each of the plurality of pieces of the input information. The information processing system 1000 may not store at least a portion of intermediate data, calculated by executing the single inference process for the input information, for an inference process for the input information after the single inference process using the machine learning model. The input information may include information requesting the generation of information that can be generated through a single inference process.

Not to store at least a portion of the intermediate data may include not to cache at least a portion of the intermediate data by at least one processor. At least a portion of the intermediate data may include at least a portion of key vectors and value vectors used in the attention mechanism of the machine learning model. The information processing system 1000 does not necessarily need to execute an inference process for the input information after the single inference process.

As described above, according to the embodiments of the present disclosure, it is possible to provide a technique of generating output information for each of a plurality of pieces of information with a small amount of calculation resources. In one aspect, according to the embodiment, it is possible to generate output information for each of a plurality of pieces of target information with a small amount of calculation. In another aspect, according to the embodiment, it is possible to generate output information for each of a plurality of pieces of target information with a small amount of memory usage. As an example, according to the present embodiment, it is possible to classify a plurality of pieces of information with a small amount of calculation resources. As another example, according to the embodiment, it is possible to generate output information based on appropriate reference information in a framework of retrieval augmented generation.

### [Hardware Configuration of Information Processing Device]

A part or all of the respective devices (the inference device 10, the generation device 20, the search device 30, and the terminal device 50) according to the above-described embodiment may be configured by hardware, or by information processing of software (program) executed by a CPU (Central Processing Unit), a GPU (Graphics Processing Unit), or the like. When the respective devices are configured by the information processing of the software, the information processing of the software may be executed by storing the software, which realizes at least a portion of the functions of the respective devices in the above-described embodiment, in a non-transitory storage medium (a non-transitory computer-readable medium, e.g., a CD-ROM (Compact Disc-Read Only Memory), a USB (Universal Serial Bus) memory, or the like) and by reading the non-transitory storage medium in a computer. Also, the software may be downloaded via a communication network. Further, the information processing by software may be executed by hardware with a part or all of the software being mounted in circuits such as an ASIC (Application Specific Integrated Circuit), a FPGA (Field Programmable Gate Array), or the like.

The storage medium storing the software may be a removable storage medium, such as an optical disk or the like, and may be a fixed storage medium, such as a hard disk, a memory, or the like. Also, the storage medium may be provided internally of the computer (a main storage device, an auxiliary storage device, or the like), or provided externally to the computer.

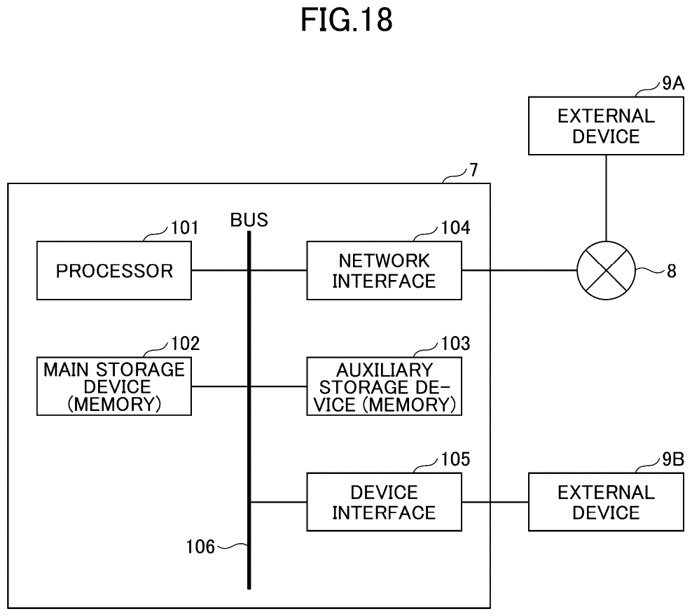

FIG. 18 is a block diagram illustrating a hardware configuration of the respective devices (the inference device 10, the generation device 20, the search device 30, and the terminal device 50) in the above-described embodiment. As one example, the respective devices include a processor 71, a main storage device 72 (memory), an auxiliary storage device 73 (memory), a network interface 74, and a device interface 75. These are connected to each other via a bus 76 and may be realized as a computer 7.

The computer 7 of FIG. 18 includes one of each of the constituting elements, but may include multiple constituting elements that are the same. Also, FIG. 18 illustrates one computer 7, but the software may be installed in multiple computers, which may each execute the same or different partial processes of the software. In this case, the computers may be in the form of distributed computing in which the computers communicate with each other via the network interface 74 or the like, thereby executing the process. That is, the respective devices (the inference device 10, the generation device 20, the search device 30, and the terminal device 50) in the above-described embodiment may be configured as a system in which one or more computers execute instructions stored in one or more storage devices, thereby realizing the functions. Also, the respective devices in the above-described embodiment may be configured such that information transmitted from a terminal is processed by one or more computers provided on the cloud and the result of the processing is transmitted to the terminal.

Various computations of the respective devices (the inference device 10, the generation device 20, the search device 30, and the terminal device 50) in the above-described embodiment may be executed in parallel using one or more processors or multiple computers connected via a network. Also, various computations may be distributed among multiple computation cores inside the processor, and executed through parallel processing. Also, a part or all of the processing, means, or the like of the present disclosure may be realized by at least one of a processor and a storage device provided on the cloud communicable with the computer 7 via a network. In this way, the devices in the above-described embodiment may be in the form of parallel computing by one or more computers.

The processor 71 may be an electronic circuit (e.g., a process circuit, a processing circuit, a processing circuitry, a CPU, a GPU, a FPGA, an ASIC, or the like) configured to perform control of a computer, an arithmetic process, or both. Also, the processor 71 may be a general-purpose processor or may be a semiconductor device including a dedicated processing circuit designed to perform specific calculation or both of the general-purpose processor and the dedicated processing circuit. Further, the processor 71 may include an optical circuit or computing functions based on quantum computing.

The processor 71 may perform computation processing based on data and software input from the devices provided internally of the computer 7, and output a computation result and a control signal to the devices. The processor 71 may control the constituting elements of the computer 7 by executing an OS (Operating System), an application, or the like of the computer 7.

The respective devices (the inference device 10, the generation device 20, the search device 30, and the terminal device 50) in the above-described embodiment may be realized by one or more processors 71. Here, the processor 71 may refer to one or more electronic circuits disposed on a single chip, or may refer to one or more electronic circuits disposed on two or more chips or on two or more devices. When using two or more electronic circuits, each of the electronic circuits may communicate by wire or wirelessly.

The main storage device 72 may store instructions to be executed by the processor 71, various data, and the like, and the information stored in the main storage device 72 may be read out by the processor 71. The auxiliary storage device 73 is a storage device other than the main storage device 72. These storage devices refer to given electronic components capable of storing electronic information, and may be semiconductor memories. The semiconductor memory may be a volatile memory or a non-volatile memory. The storage device for storing the various data and the like in the respective devices (the inference device 10, the generation device 20, the search device 30, and the terminal device 50) in the above-described embodiment may be realized by the main storage device 72 or the auxiliary storage device 73, or may be realized by an internal memory provided internally of the processor 71. For example, the respective storage units in the above-described embodiment may be realized by the main storage device 72 or the auxiliary storage device 73.

When the respective devices (the inference device 10, the generation device 20, the search device 30, and the terminal device 50) in the above-described embodiment is configured with at least one storage device (memory) and at least one processor connected (coupled) to the at least one storage device, at least one processor may be connected to a single storage device. Alternatively, at least one storage device may be connected to a single processor. Also, at least one processor of the multiple processors may be connected to the at least one storage device of the multiple storage devices. Also, such a configuration may be realized by a storage device and a processor included in multiple computers. Further, the configuration may include the storage device integrated with the processor (e.g., a cache memory including a L1 cache, a L2 cache, or the like).

The network interface 74 is an interface for connecting to a communication network 8, by wire or wirelessly. The network interface 74 may use an appropriate interface such as an interface conforming to existing communication standards. Exchange of information with an external device 9A connected via the communication network 8 may be performed via the network interface 74. Note that, the communication network 8 may be a WAN (Wide Area Network), a LAN (Local Area Network), a PAN (Personal Area Network), or the like, or may be a combination thereof, as long as exchange of information is performed between the computer 7 and the external device 9A. Examples of the WAN include the Internet and the like. Examples of the LAN include the IEEE 802.11, ETHERNET (registered trademark), and the like. Examples of the PAN include Bluetooth (registered trademark), NFC (Near Field Communication), and the like.

The device interface 75 may be an interface, such as a USB or the like, that directly connects to an external device 9B.

The external device 9A is a device that is connected to the computer 7 via a network. The external device 9B is a device that is directly connected to the computer 7.

The external device 9A or the external device 9B may be an input device, as one example. The input device may be a device, such as a camera, a microphone, a motion capture device, various sensors, a keyboard, a mouse, a touch panel, or the like, and provides obtained information to the computer 7. Also, the external device 9A or the external device 9B may be a device including an input unit, a memory, and a processor, such as a personal computer, a tablet terminal, a smartphone, or the like.

Also, the external device 9A or the external device 9B may be an output device, as one example. The output device may be a display device, such as a LCD (Liquid Crystal Display), an organic EL (Electro Luminescence) panel, or the like, or may be a speaker or the like that outputs voice or the like. Also, the external device 9A or the external device 9B may be a device including an output unit, a memory, and a processor, such as a personal computer, a tablet terminal, a smartphone, or the like.

Also, the external device 9A or the external device 9B may be a storage device (memory). For example, the external device 9A may be a network storage or the like, and the external device 9B may be a storage, such as an HDD or the like.

Also, the external device 9A or the external device 9B may be a device having the functions of a part of the constituting elements of the respective devices (the inference device 10, the generation device 20, the search device 30, and the terminal device 50) in the above-described embodiment. That is, the computer 7 may transmit a part or all of the processing results of the external device 9A or the external device 9B, or may receive a part or all of the processing results of the external device 9A or the external device 9B.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), in a case where an expression, such as “data as an input”, “using data”, “based on data”, “according to data”, or “in accordance with data” (including similar expressions) is used, such a case may, unless otherwise noted, encompass a case in which data themselves are used and a case in which data obtained by processing data (e.g., data obtained by adding noise, normalized data, feature extracted from data, and intermediate representation of data) are used. If it is described that any result can be obtained “based on data as an input”, “using data”, “based on data”, “according to data”, or “in accordance with data” (including similar expressions), unless otherwise noted, a case in which the result is obtained based on only the data is included, and a case in which the result is obtained affected by another data other than the data, factors, conditions, and/or states is included. If it is described that “data are output” (including similar expressions), unless otherwise noted, a case in which data themselves are used as an output is included, and a case in which data obtained by processing data in some way (e.g., data obtained by adding noise, normalized data, feature extracted from data, and intermediate representation of various data) are used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general-purpose processor, the processor may have a hardware configuration that can perform the operation B and be configured to actually perform the operation B by setting a permanent or temporary program (i.e., an instruction). If the element A is a dedicated processor or a dedicated arithmetic circuit, a circuit structure or the like of the processor may be implemented so as to actually perform the operation B irrespective of whether the control instruction and the data are actually attached.

In the present specification (including the claims), if a term indicating containing or possessing (e.g., “comprising/including” and “having”) is used, the term is intended as an open-ended term, including an inclusion or possession of an object other than a target object indicated by the object of the term. If the object of the term indicating an inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, states, and/or the like, and that the advantage/result is not necessarily obtained by the configuration. The advantage/result is merely an advantage/result that results from the configuration described in the embodiment when various factors, conditions, and/or states are satisfied, and is not necessarily obtained in the claimed invention that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” (including similar expressions) is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices may store only a portion of the data or may store an entirety of the data. Also, a configuration in which some of the multiple storage devices store data may be included.

In the present specification (including the claims), such terms as “first”, “second”, and the like are used merely as a way of distinguishing two or more elements, and are not necessarily intended to impose any technical meaning, such as a temporal aspect, a spatial aspect, an order, a quantity, or the like, on the target. Therefore, for example, references to a first element and a second element do not necessarily mean, for example, that only two elements can be employed in the context, the first element needs to precede the second element, and the first element needs to exist because the second element exists.

Although the embodiments of the present disclosure have been described in detail above, the present disclosure is not limited to the individual embodiments described above. Various additions, modifications, substitutions, partial deletions, and the like may be made without departing from the conceptual idea and spirit of the invention derived from the contents defined in the claims and the equivalents thereof. For example, in the embodiments described above, when numerical values or mathematical formulae are used for description, these are used for illustrative purposes and do not limit the scope of the present disclosure. Additionally, the orders of operations described in the embodiments are illustrative and do not limit the scope of the present disclosure.

In the disclosed technique, embodiments according to the following clauses are conceivable.

### (Clause 1)

An information processing system, including:
at least one memory; and
at least one processor, wherein
the at least one processor is configured to:
   obtain information related to an output candidate and a plurality of pieces of target information,
   calculate first intermediate data by inputting the information related to the output candidate into a machine learning model, and
   generate output information for each of the plurality of pieces of the target information by executing a single inference process using the machine learning model for each of the plurality of pieces of the target information by using at least a portion of the first intermediate data.

### (Clause 2)

The information processing system according to clause 1, wherein
the information related to the output candidate includes identification information of an option, and
the identification information of the option is information that can be represented using information that can be generated through the single inference process.

### (Clause 3)

The information processing system according to clause 1 or 2, wherein
the information related to the output candidate includes an option, and
the option is information that can be represented using information that can be generated through the single inference process.

### (Clause 4)

The information processing system according to any one of clauses 1 to 3, wherein
the information related to the output candidate includes information requesting generation of a number, and
the number is information that can be represented using information that can be generated through the single inference process.

### (Clause 5)

The information processing system according to any one of clauses 1 to 4, wherein
the information related to the output candidate includes information requesting generation of information that can be generated through the single inference process.

### (Clause 6)

The information processing system according to any one of clauses 1 to 5, wherein
the at least one processor is configured not to
   store at least a portion of second intermediate data, calculated by executing the single inference process for the target information, for an inference process for the target information after the single inference process using the machine learning model.

### (Clause 7)

The information processing system according to clause 6, wherein
not to store the at least the portion of the second intermediate data includes not to cache the at least the portion of the second intermediate data by the at least one processor.

### (Clause 8)

The information processing system according to clause 6 or 7, wherein
the at least the portion of the second intermediate data includes at least a portion of key vectors and value vectors used in an attention mechanism of the machine learning model.

### (Clause 9)

The information processing system according to any one of clauses 1 to 8, wherein
the at least one processor is configured to:
   cache the at least the portion of the first intermediate data, and
   execute the single inference process using the machine learning model for each of the plurality of pieces of the target information by using the cached at least the portion of the first intermediate data.

### (Clause 10)

The information processing system according to clause 9, wherein
the at least the portion of the first intermediate data includes at least a portion of key vectors and value vectors used in an attention mechanism of the machine learning model.

### (Clause 11)

The information processing system according to any one of clauses 1 to 10, wherein
the at least one processor is configured not to
   execute an inference process for the target information after the single inference process.

### (Clause 12)

The information processing system according to any one of clauses 1 to 11, wherein
the at least one processor is configured to
   generate, in parallel, pieces of the output information for two or more pieces of the target information.

### (Clause 13)

The information processing system according to any one of clauses 1 to 12, wherein
the information related to the output candidate includes at least information related to first classification and information related to second classification,
the at least one processor is configured, in the single inference process, to
   input, into the machine learning model, information in which the target information is linked to a token for an option of the first classification,
the token for the option of the first classification is linked after the target information,
the token for the option of the first classification includes at least a token for a first option and a token for a second option, the token for the second option being linked after the token for the first option, and
the token for the second option is set not to refer to the token for the first option in the single inference process.

### (Clause 14)

The information processing system according to any one of clauses 1 to 13, wherein
the at least one processor is configured to
   learn another model based on the output information for each of the plurality of pieces of the target information, and ground truth information.

### (Clause 15)

The information processing system according to any one of clauses 1 to 14, wherein
the at least one processor is configured to
   generate second output information for each of the plurality of pieces of the target information by inputting, into another model, the output information for each of the plurality of pieces of the target information.

### (Clause 16)

The information processing system according to any one of clauses 1 to 15, wherein
the at least one processor is configured to:
   select one or more pieces of the target information for use in generation of third output information based on the output information for each of the plurality of pieces of the target information,
   generate input information to be input to at least one of the machine learning model or another machine learning model based on a generation request and the one or more pieces of the target information, and
   generate the third output information by inputting the input information to at least one of the machine learning model or the another machine learning model.

### (Clause 17)

The information processing system according to clause 16, wherein
the information related to the output candidate is information that is generated based on the generation request.

### (Clause 18)

The information processing system according to clause 16 or 17, wherein
the plurality of pieces of the target information are information that is obtained through search based on a predetermined search condition, and
the predetermined search condition is determined based on the generation request.

### (Clause 19)

An information processing device, including:
at least one memory; and
at least one processor, wherein
the at least one processor is configured to:
   display, on a display device, information for obtaining information related to an output candidate,
   display, on the display device, information for obtaining a plurality of pieces of target information, and
   display, on the display device, an inference result based on output information for each of the plurality of pieces of the target information, and
the output information for each of the plurality of pieces of the target information is information that is generated by executing a single inference process using a machine learning model for each of the plurality of pieces of the target information by using at least a portion of intermediate data calculated by inputting the information related to the output candidate into the machine learning model.

### (Clause 20)

The information processing device according to clause 19, wherein
the at least one processor is configured to:
   obtain, from a user, information related to an option, and
   generate the information related to the output candidate based on the information related to the option.

### (Clause 21)

The information processing device according to clause 20, wherein
the information related to the option includes at least one of:
   identification information of the option that can be represented by using information that can be generated through the single inference process, or
   the option that can be represented by using the information that can be generated through the single inference process.

### (Clause 22)

The information processing device according to clause 20 or 21, wherein
the inference result includes at least one of:
   a probability value of the option,
   an option selected based on probability information included in the output information, or
   information based on the selected option.

### (Clause 23)

The information processing device according to any one of clauses 19 to 22, wherein
the at least one processor is configured to
   obtain the plurality of pieces of the target information from an electronic file designated by a user.

### (Clause 24)

An information processing system, including:
at least one memory; and
at least one processor, wherein
the at least one processor is configured:
   to obtain a plurality of pieces of input information,
   to generate output information for each of the plurality of pieces of the input information by executing a single inference process using a machine learning model for each of the plurality of pieces of the input information, and
   not to store at least a portion of intermediate data, calculated by executing the single inference process for the input information, for an inference process for the input information after the single inference process using the machine learning model, and
the input information includes information requesting generation of information that can be generated through the single inference process.

### (Clause 25)

The information processing system according to clause 24, wherein
not to store the at least the portion of the intermediate data includes not to cache the at least the portion of the intermediate data by the at least one processor.

### (Clause 26)

The information processing system according to clause 24 or 25, wherein
the at least the portion of the intermediate data includes at least a portion of key vectors and value vectors used in an attention mechanism of the machine learning model.

### (Clause 27)

The information processing system according to any one of clauses 24 to 26, wherein
the at least one processor is configured not to
   execute an inference process for the input information after the single inference process.

### (Clause 28)

An information processing method, including:
obtaining, by at least one processor, information related to an output candidate and a plurality of pieces of target information;
calculating, by the at least one processor, first intermediate data by inputting the information related to the output candidate into a machine learning model; and
generating, by the at least one processor, output information for each of the plurality of pieces of the target information by executing a single inference process using the machine learning model for each of the plurality of pieces of the target information by using at least a portion of the first intermediate data.

### (Clause 29)

An information processing method, including:
displaying, on a display device, information for obtaining information related to an output candidate, by at least one processor;
displaying, on the display device, information for obtaining a plurality of pieces of target information, by the at least one processor; and
displaying, on the display device, an inference result based on output information for each of the plurality of pieces of the target information, by the at least one processor, wherein
the output information for each of the plurality of pieces of the target information is information that is generated by executing a single inference process using a machine learning model for each of the plurality of pieces of the target information by using at least a portion of intermediate data calculated by inputting the information related to the output candidate into the machine learning model.

### (Clause 30)

An information processing method, including:
obtaining, by at least one processor, a plurality of pieces of input information;
generating, by the at least one processor, output information for each of the plurality of pieces of the input information by executing a single inference process using a machine learning model for each of the plurality of pieces of the input information; and
not storing, by the at least one processor, at least a portion of intermediate data, calculated by executing the single inference process for the input information, for an inference process for the input information after the single inference process using the machine learning model, wherein
the input information includes information requesting generation of information that can be generated through the single inference process.

### (Clause 31)

A non-transitory computer-readable storage medium having stored therein a program which, when executed by at least one processor, causes the at least one processor to execute a process including:
obtaining information related to an output candidate and a plurality of pieces of target information;
calculating first intermediate data by inputting the information related to the output candidate into a machine learning model; and
generating output information for each of the plurality of pieces of the target information by executing a single inference process using the machine learning model for each of the plurality of pieces of the target information by using at least a portion of the first intermediate data.

### (Clause 32)

A non-transitory computer-readable storage medium having stored therein a program which, when executed by at least one processor, causes the at least one processor to execute a process including:
displaying, on a display device, information for obtaining information related to an output candidate;
displaying, on the display device, information for obtaining a plurality of pieces of target information; and
displaying, on the display device, an inference result based on output information for each of the plurality of pieces of the target information, wherein
the output information for each of the plurality of pieces of the target information is information that is generated by executing a single inference process using a machine learning model for each of the plurality of pieces of the target information by using at least a portion of intermediate data calculated by inputting the information related to the output candidate into the machine learning model.

### (Clause 33)

A program for causing at least one processor to execute a process including:
obtaining a plurality of pieces of input information;
generating output information for each of the plurality of pieces of the input information by executing a single inference process using a machine learning model for each of the plurality of pieces of the input information; and
not storing at least a portion of intermediate data, calculated by executing the single inference process for the input information, for an inference process for the input information after the single inference process using the machine learning model, wherein
the input information includes information requesting generation of information that can be generated through the single inference process.

What is claimed is:

1. An information processing system, comprising:
at least one memory; and
at least one processor, wherein
the at least one processor is configured to:
obtain information related to an output candidate and a plurality of pieces of target information,
calculate first intermediate data by inputting the information related to the output candidate into a machine learning model, and
generate output information for each of the plurality of pieces of the target information by executing a single inference process using the machine learning model for each of the plurality of pieces of the target information by using at least a portion of the first intermediate data.

2. The information processing system according to claim 1, wherein
the information related to the output candidate includes at least one of:
identification information of an option,
the option,
information requesting generation of a number, or
information requesting generation of information that can be generated through the single inference process,
the identification information of the option is information that can be represented using the information that can be generated through the single inference process,
the option is the information that can be represented using the information that can be generated through the single inference process, and
the number is the information that can be represented using the information that can be generated through the single inference process.

3. The information processing system according to claim 1, wherein
the at least one processor is configured not to
store at least a portion of second intermediate data, calculated by executing the single inference process for the target information, for an inference process for the target information after the single inference process using the machine learning model.

4. The information processing system according to claim 1, wherein
the at least one processor is configured to:
cache the at least the portion of the first intermediate data, and
execute the single inference process using the machine learning model for each of the plurality of pieces of the target information by using the cached at least the portion of the first intermediate data.

5. The information processing system according to claim 1, wherein
the at least one processor is configured not to
execute an inference process for the target information after the single inference process.

6. The information processing system according to claim 1, wherein
the at least one processor is configured to
generate, in parallel, pieces of the output information for two or more pieces of the target information.

7. The information processing system according to claim 1, wherein
the information related to the output candidate includes at least information related to first classification and information related to second classification,
the at least one processor is configured, in the single inference process, to
input, into the machine learning model, information in which the target information is linked to a token for an option of the first classification,
the token for the option of the first classification is linked after the target information,
the token for the option of the first classification includes at least a token for a first option and a token for a second option, the token for the second option being linked after the token for the first option, and
the token for the second option is set not to refer to the token for the first option in the single inference process.

8. The information processing system according to claim 1, wherein
the at least one processor is configured to
learn another model based on the output information for each of the plurality of pieces of the target information, and ground truth information.

9. The information processing system according to claim 1, wherein
the at least one processor is configured to
generate second output information for each of the plurality of pieces of the target information by inputting, into another model, the output information for each of the plurality of pieces of the target information.

10. The information processing system according to claim 1, wherein
the at least one processor is configured to:
select one or more pieces of the target information for use in generation of third output information based on the output information for each of the plurality of pieces of the target information,
generate input information to be input into at least one of the machine learning model or another machine learning model based on a generation request and the one or more pieces of the target information, and
generate the third output information by inputting the input information into at least one of the machine learning model or the another machine learning model.

11. The information processing system according to claim 10, wherein
the information related to the output candidate is information that is generated based on the generation request.

12. The information processing system according to claim 10, wherein
the plurality of pieces of the target information are information that is obtained through search based on a predetermined search condition, and
the predetermined search condition is determined based on the generation request.

13. An information processing device, comprising:
at least one memory; and
at least one processor, wherein
the at least one processor is configured to:
display, on a display device, information for obtaining information related to an output candidate,
display, on the display device, information for obtaining a plurality of pieces of target information, and
display, on the display device, an inference result based on output information for each of the plurality of pieces of the target information, and
the output information for each of the plurality of pieces of the target information is information that is generated by executing a single inference process using a machine learning model for each of the plurality of pieces of the target information by using at least a portion of intermediate data calculated by inputting the information related to the output candidate into the machine learning model.

14. The information processing device according to claim 13, wherein
the at least one processor is configured to
obtain, from a user, information related to an option, wherein
the information related to the output candidate is generated based on the information related to the option.

15. The information processing device according to claim 14, wherein
the information related to the option includes at least one of:
identification information of the option that can be represented by using information that can be generated through the single inference process, or
the option that can be represented by using the information that can be generated through the single inference process.

16. The information processing device according to claim 13, wherein
the at least one processor is configured to:
obtain an option from a user, and
assign identification information to the option,
the information related to the output candidate is generated based on the option and the identification information, and
the identification information is information that can be represented using information that can be generated through the single inference process.

17. The information processing device according to claim 14, wherein
the inference result includes at least one of:
a probability value of the option,
an option selected based on probability information included in the output information, or
information based on the selected option.

18. An information processing system, comprising:
at least one memory; and
at least one processor, wherein
the at least one processor is configured:
to obtain a plurality of pieces of input information,
to generate output information for each of the plurality of pieces of the input information by executing a single inference process using a machine learning model for each of the plurality of pieces of the input information, and
not to store at least a portion of intermediate data, calculated by executing the single inference process for the input information, for an inference process for the input information after the single inference process using the machine learning model, and
the input information includes information requesting generation of information that can be generated through the single inference process.

19. An information processing method, comprising:
obtaining, by at least one processor, information related to an output candidate and a plurality of pieces of target information;
calculating, by the at least one processor, first intermediate data by inputting the information related to the output candidate into a machine learning model; and
generating, by the at least one processor, output information for each of the plurality of pieces of the target information by executing a single inference process using the machine learning model for each of the plurality of pieces of the target information by using at least a portion of the first intermediate data.

20. An information processing method, comprising:
displaying, on a display device, information for obtaining information related to an output candidate, by at least one processor;
displaying, on the display device, information for obtaining a plurality of pieces of target information, by the at least one processor; and
displaying, on the display device, an inference result based on output information for each of the plurality of pieces of the target information, by the at least one processor, wherein
the output information for each of the plurality of pieces of the target information is information that is generated by executing a single inference process using a machine learning model for each of the plurality of pieces of the target information by using at least a portion of intermediate data calculated by inputting the information related to the output candidate into the machine learning model.
